(19) United States
(12) Patent Application Publication
(10) Pub. No.: US 2012/0006025 A1
(43) Pub. Date: Jan. 12, 2012

(54) THERMAL POWER PLANT USING LOW-GRADE COAL AS FUEL

(75) Inventors: Yoshinori Koyama, Tokyo (JP); Takashi Yamamoto, Tokyo (JP); Osamu Shinada, Tokyo (JP); Hiromi Ishii, Tokyo (JP); Hitoji Yamada, Tokyo (JP); Shozo Kaneko, Tokyo (JP); Kimishiro Tokuda, Nagasaki (JP); Isao Mochida, Fukuoka (JP); Tatsurou Harada, Fukuoka (JP)

(73) Assignees: KYUSHU ELECTRIC POWER CO., INC., Fukuoka-shi, Fukuoka (JP); MITSUBISHI HEAVY INDUSTRIES, LTD., Tokyo (JP)

(21) Appl. No.: 13/201,190

(22) PCT Filed: Dec. 10, 2009
(86) PCT No.: PCT/JP2009/070663

§ 371 Date: Sep. 27, 2011

(30) Foreign Application Priority Data
Feb. 27, 2009 (JP) 2009-047351
Aug. 5, 2009 (JP) 2009-182771

(51) Int. Cl. F01K 13/00; F26B 25/06

(52) U.S. Cl. 60/670; 34/218

(57) ABSTRACT

A thermal power plant that uses low-grade coal as fuel and allows for increased thermal efficiency of the entire plant is provided. The thermal power plant includes a drying device (3) that dries the low-grade coal to be supplied to a lignite mill (coal pulverizer) (4), and a drying-gas heater (13) that heats air to be supplied to the drying device (3) so as to be used for drying the low-grade coal. A condenser (12) and the drying-gas heater (13) are connected with each other via a heat exchanger (19), and exhaust heat from the condenser (12) is used as a heat source for heating the air.

### TECHNICAL FIELD

The present invention relates to a thermal power plant that uses low-grade coal (such as sub-bituminous coal or lignite having a moisture content that exceeds about 20 percent by mass) as fuel, and particularly, to a lignite-fired thermal power plant that uses lignite as fuel.

### BACKGROUND ART

Because low-grade coal has a high moisture content, even if it is pulverized into particles small enough that the coal can be combusted and used as fuel for a boiler, heat loss (i.e., latent heat) caused by the moisture in combustion gas combusted within a boiler furnace increases, which is a problem in that the thermal efficiency of the entire plant decreases.

In light of this, an invention for increasing the thermal efficiency of the entire plant by preliminarily drying the low-grade coal serving as fuel is disclosed in, for example, Patent Literature 1. FIG. 1 in Patent Literature 1 discloses a collision-type drying and pulverizing device.

### CITATION LIST

### Patent Literature

{PTL 1} Japanese Unexamined Patent Application, Publication No. 2005-241120

### SUMMARY OF INVENTION

### Technical Problem

The amount of reserves of lignite, which is low-grade coal, is about the same as that of bituminous coal, which is high-grade coal, and because lignite is generally a low-sulfur material, lignite-fired thermal power plants with higher thermal efficiency are desired in the future.

In view of the circumstances described above, it is an object of the present invention to provide a thermal power plant that uses low-grade coal as fuel and that allows for increased thermal efficiency of the entire plant by efficiently drying the low-grade coal serving as fuel.

### Solution to Problem

In order to achieve the aforementioned object, the present invention employs the following solutions.

In a steam generating plant according to an aspect of the present invention using low-grade coal as fuel and including a boiler that generates steam, a steam turbine that is driven by the steam, a condenser that captures the steam, after the steam has fulfilled its role in the steam turbine, and condenses the steam, and a coal pulverizer that pulverizes the low-grade coal to be supplied to the boiler into particles small enough that the low-grade coal can be used as fuel for the boiler, the steam generating plant includes a drying device that dries the low-grade coal to be supplied to the coal pulverizer, and a drying-gas heater that heats air to be supplied to the drying device so as to be used for drying the low-grade coal. The condenser and the drying-gas heater are connected with each other via a heat exchanger, and exhaust heat from the condenser is used as a heat source for heating the air.

With the steam generating plant according to the above aspect, the exhaust heat from the condenser, which is to be discharged outside the system in the related art after the exhaust heat has fulfilled its role in a steam cycle, is effectively used for drying the low-grade coal (such as lignite) serving as fuel for the boiler, so that heat loss caused by moisture (i.e., latent heat) in the boiler is reduced, thereby increasing the thermal efficiency of the entire plant.

The collision-type drying and pulverizing device disclosed in FIG. 1 in Patent Literature 1 is suitable for use as the drying device.

In the aforementioned steam generating plant, it is preferable that the air used for drying the low-grade coal within the drying device be forced into the boiler.

With such a steam generating plant, since the cooled air used for drying the low-grade coal (such as lignite) within the drying device is forced into the boiler so as to be used as combustion air, an air-preheater air fan that forces the combustion air into the boiler can be reduced in volume and made more compact. Moreover, moisture, smoke dust, and odorous components released during the drying process of the low-grade coal can be burned and deodorized in the boiler.

In the aforementioned steam generating plant, the air used for drying the low-grade coal within the drying device may be directly released to the atmosphere via a smokestack located downstream of the boiler.

With such a steam generating plant, since the cooled air used for drying the low-grade coal (such as lignite) does not need to be forced into the boiler (for example, the air is simply made to flow between an induced draft fan and the smokestack), a drying air fan that forces the drying air into the drying device can have a compact head, and the induced draft fan can also be reduced in volume.

In the aforementioned steam generating plant, it is preferable that a heater that further heats the heated air to be supplied to the drying device from the drying-gas heater be provided between the drying device and the drying-gas heater.

With such a steam generating plant, since the heater heats the air (primary drying air) to be supplied to the drying device to a temperature higher than that in the aforementioned steam generating plant, the flow rate of the air to be supplied to the drying device can be reduced, whereby the drying air fan can be further reduced in volume and made more compact.

Because the diversion flow rate at which the temperature of the air to be supplied to the drying device increases can be reduced, and the drying efficiency of the drying device is increased, the drying device can be reduced in volume and made compact.

In a steam generating plant according to another aspect of the present invention using low-grade coal as fuel and including a boiler that generates steam, a steam turbine that is driven by the steam, a condenser that captures the steam, after the steam has fulfilled its role in the steam turbine, and condenses the steam, and a coal pulverizer that pulverizes the low-grade coal to be supplied to the boiler into particles small enough that the low-grade coal can be used as fuel for the boiler, the steam generating plant includes a drying device that dries the low-grade coal to be supplied to the coal pulverizer, and a drying-gas heater that heats boiler exhaust gas from the boiler, which is to be supplied to the drying device so as to be used for drying the low-grade coal. The condenser and the drying-gas heater are connected with each other via a heat exchanger, and exhaust heat from the condenser is used as a heat source for heating the boiler exhaust gas.

With the steam generating plant according to the above aspect, the exhaust heat from the condenser, which is to be discharged outside the system in the related art after the exhaust heat has fulfilled its role in a steam cycle, and sensible heat (exhaust heat) of low-temperature combustion gas to be discharged from the boiler to a smokestack are effectively used for drying the low-grade coal (such as lignite) serving as fuel for the boiler, so that heat loss caused by moisture (i.e., latent heat) in the boiler is reduced, thereby increasing the thermal efficiency of the entire plant.

Because the oxygen concentration of boiler exhaust gas is lower than that of air, the low-grade coal, which readily increases in temperature and is readily naturally oxidized as well as having high ignitability, can be dried at a higher temperature. As a result, high drying efficiency and safety can be achieved.

In the aforementioned steam generating plant, it is preferable that the boiler exhaust gas used for drying the low-grade coal within the drying device be forced into the boiler.

With such a steam generating plant, the cooled boiler exhaust gas used for drying the low-grade coal (such as lignite) within the drying device is forced into the boiler, so that moisture, smoke dust, and odorous components released during the drying process can be burned and deodorized in the boiler.

In the aforementioned steam generating plant, the boiler exhaust gas used for drying the low-grade coal within the drying device may be directly released to the atmosphere via a smokestack located downstream of the boiler.

With such a steam generating plant, since the cooled boiler exhaust gas used for drying the low-grade coal (such as lignite) within the drying device does not need to be forced into the large boiler (for example, the boiler exhaust gas is simply made to flow between an induced draft fan and the smokestack), a drying exhaust-gas fan that forces the drying exhaust gas into the drying device can have a compact head, and the induced draft fan can also be reduced in volume.

In the aforementioned steam generating plant, it is preferable that a heater that further heats the boiler exhaust gas to be supplied to the drying device from the drying-gas heater be provided between the drying device and the drying-gas heater.

With such a steam generating plant, since the heater heats the boiler exhaust gas (primary drying exhaust gas) to be supplied to the drying device to a temperature higher than that in the aforementioned steam generating plant, the flow rate of the boiler exhaust gas to be supplied to the drying device can be reduced, whereby the drying exhaust-gas fan can be further reduced in volume and made more compact.

Because the diversion flow rate at which the temperature of the boiler exhaust gas to be supplied to the drying device increases can be reduced, and the drying efficiency of the drying device is increased, the drying device can be reduced in volume and made compact.

It is preferable that the aforementioned steam generating plant further include a moisture meter that detects moisture in the low-grade coal to be supplied to the coal pulverizer from the drying device, and a heat input level in the heater be set on the basis of a detection result obtained by the moisture meter.

With such a steam generating plant, because the moisture in the low-grade coal (such as lignite) to be discharged from the drying device is maintained at a desired percentage by weight (e.g., about 20 percent by weight), natural oxidation and spontaneous combustion of the low-grade coal (such as lignite) from the drying device can be prevented within the coal pulverizer, thereby allowing for increased safety and reliability.

As an alternative to the technique of directly measuring the moisture in the low-grade coal, the moisture in the low-grade coal may be measured from the flow rate of and the moisture in the drying gas to be supplied to the drying device, the moisture in the coal, and the flow rate of and the moisture in the drying gas at the outlet of the drying device. Specifically, the amount of drying gas is adjustable in accordance with the initial moisture and dryness of the low-grade coal so that the drying power (of the fan) and the extraction steam flow rate (for the heater) can be reduced, thereby allowing for higher efficiency.

In the aforementioned steam generating plant, it is preferable that a heat pump be provided in place of the heat exchanger.

With such a steam generating plant, since the exhaust heat from the condenser is transmitted to the drying-gas heater via the compression heat pump, which has good thermal transmission efficiency, the thermal efficiency of the entire plant can be further increased.

Because the temperature of the air or the boiler exhaust gas to be supplied to the drying device is higher than that in the aforementioned steam generating plant due to the compression heat pump, the flow rate of the air or the boiler exhaust gas to be supplied to the drying device can be reduced, whereby the drying air fan or the drying exhaust-gas fan can be further reduced in volume and made more compact.

Because the diversion flow rate at which the temperature of the air or the boiler exhaust gas to be supplied to the drying device increases can be reduced, and the drying efficiency of the drying device is increased, the drying device can be reduced in volume and made compact.

In a steam generating plant according to another aspect of the present invention using low-grade coal as fuel and including a boiler that generates steam, a steam turbine that is driven by the steam, a condenser that captures the steam, after the steam has fulfilled its role in the steam turbine, and condenses the steam, and a coal pulverizer that pulverizes the low-grade coal to be supplied to the boiler into particles small enough that the low-grade coal can be used as fuel for the boiler, the steam generating plant includes a drying device that dries the low-grade coal to be supplied to the coal pulverizer, and a drying-gas heater that heats air and boiler exhaust gas from the boiler, which are to be supplied to the drying device so as to be used for drying the low-grade coal. The condenser and the drying-gas heater are connected with each other via a heat exchanger, and exhaust heat from the condenser is used as a heat source for heating the air and the boiler exhaust gas.

With the steam generating plant according to the above aspect, the air, the exhaust heat from the condenser, and sensible heat (exhaust heat) of boiler combustion gas are used for drying the low-grade coal (such as lignite) serving as fuel for the boiler, so that heat loss caused by moisture (i.e., latent heat) in the boiler is reduced, thereby increasing the thermal efficiency of the entire plant.

Because the oxygen concentration of boiler exhaust gas is lower than that of air, the low-grade coal, which readily increases in temperature and is readily naturally oxidized as well as having high ignitability, can be dried at a higher temperature. As a result, high drying efficiency and safety can be achieved.

In the aforementioned steam generating plant, it is preferable that the air and the boiler exhaust gas used for drying the low-grade coal within the drying device be forced into the boiler.

With such a steam generating plant, the air and the boiler exhaust gas used for drying the low-grade coal (such as lignite) within the drying device are forced into the boiler, so that moisture, smoke dust, and odorous components released during the drying process can be burned and deodorized in the boiler.

In the aforementioned steam generating plant, the air and the boiler exhaust gas used for drying the low-grade coal within the drying device may be directly released to the atmosphere via a smokestack located downstream of the boiler.

With such a steam generating plant, since the air and the boiler exhaust gas used for drying the low-grade coal (such as lignite) do not need to be forced into the boiler, which has large resistance (for example, the air and the boiler exhaust gas are simply made to flow between an induced draft fan and the smokestack), a drying exhaust-gas fan that forces the drying exhaust gas into the drying device can have a compact head, and the induced draft fan can also be reduced in volume.

In the aforementioned steam generating plant, it is preferable that a heater that further heats the air and the boiler exhaust gas to be supplied to the drying device from the drying-gas heater be provided between the drying device and the drying-gas heater.

With such a steam generating plant, since the heater heats the air and the boiler exhaust gas (primary drying exhaust gas) to be supplied to the drying device to a temperature higher than that in the aforementioned steam generating plant, the flow rate of the boiler exhaust gas to be supplied to the drying device can be reduced, whereby the drying exhaust-gas fan can be further reduced in volume and made more compact.

Because the diversion flow rate at which the temperature of the air and the boiler exhaust gas to be supplied to the drying device increases can be reduced, and the drying efficiency of the drying device is increased, the drying device can be reduced in volume and made compact.

It is preferable that the aforementioned steam generating plant further include a moisture meter that detects moisture in the low-grade coal to be supplied to the coal pulverizer from the drying device, and a heat input level in the heater be set on the basis of a detection result obtained by the moisture meter.

With such a steam generating plant, because the moisture in the low-grade coal (such as lignite) to be discharged from the drying device is maintained at a desired percent age by weight (e.g., about 20 percent by weight), natural oxidation and spontaneous combustion of the low-grade coal (such as lignite) from the drying device can be prevented within the coal pulverizer, thereby allowing for increased safety and reliability.

As an alternative to the technique of directly measuring the moisture in the low-grade coal, the moisture in the low-grade coal can be measured from the flow rate of and the moisture in the drying gas to be supplied to the drying device, the moisture in the coal, and the flow rate of and the moisture in the drying gas at the outlet of the drying device. Specifically, the amount of drying gas is adjustable in accordance with the initial moisture and dryness of the low-grade coal so that the drying power (of the fan) and the extraction steam flow rate (for the heater) can be reduced, thereby allowing for higher efficiency.

In the aforementioned steam generating plant, it is preferable that a heat pump be provided in place of the heat exchanger.

With such a steam generating plant, since the exhaust heat from the condenser is transmitted to the drying-gas heater via the compression heat pump, which has good thermal transmission efficiency, the thermal efficiency of the entire plant can be further increased.

Because the temperature of the air or the boiler exhaust gas to be supplied to the drying device is higher than that in the aforementioned steam generating plant due to the compression heat pump, the flow rate of the air or the boiler exhaust gas to be supplied to the drying device can be reduced, whereby the drying air fan or the drying exhaust-gas fan can be further reduced in volume and made more compact.

Because the diversion flow rate at which the temperature of the air or the boiler exhaust gas to be supplied to the drying device increases can be reduced, and the drying efficiency of the drying device is increased, the drying device can be reduced in volume and made compact.

In the aforementioned steam generating plant, a mixture ratio of the air and the boiler exhaust gas to be used for drying the low-grade coal within the drying device may be measured and adjusted by an oxygen meter disposed at an inlet of the drying device.

With such a steam generating plant, the air, which has a relatively low temperature due to the exhaust heat from the condenser, and the boiler exhaust gas having a high temperature are mixed with each other so that the temperature of the drying gas to be supplied to the drying device can be easily adjusted (i.e., increased and decreased), and by mixing the boiler exhaust gas having low oxygen concentration (about 5% or lower) with the air, the oxygen concentration at the inlet of the drying device can be set to a low value.

The oxygen concentration of the drying gas at the inlet of the drying device may be calculated on the basis of the oxygen concentration in the boiler exhaust gas (used for controlling the boiler) and the oxygen concentration in the atmosphere (21%). It is preferable that the oxygen concentration (wet) be controlled so as to achieve 13% or lower.

In the aforementioned steam generating plant, it is preferable that the air be heated by boiler exhaust gas from the boiler (the heating method in this case includes direct heating method by mixing and an indirect mixing method by heat exchange) so as to be used for drying the low-grade coal supplied to the coal pulverizer.

With such a steam generating plant, the warm air that has undergone heat exchange (i.e., has been heated) within, for example, an air preheater further removes the moisture from (i.e., further dries) the low-grade coal (such as lignite) supplied to the coal pulverizer from the drying device, so that heat loss caused by moisture (latent heat) in combustion gas combusted within a boiler furnace decreases, thereby further increasing the thermal efficiency of the entire plant.

In a drying system according to an aspect of the present invention that dries low-grade coal within a drying device before the low-grade coal is supplied to a coal pulverizer, drying gas used for drying the low-grade coal circulates within a pipe connected to the drying device and forming a closed system.

With the drying system according to the above aspect, since the drying gas circulates within a closed system, the oxygen concentration (wet) in the drying gas can be reduced to below 13%, or preferably, to below 10%, so that natural oxidation and spontaneous combustion of the low-grade coal (such as lignite) can be prevented, thereby allowing for increased safety and reliability.

The low-grade-coal particles and dust mixed during the low-grade-coal drying process within the drying device can be prevented from being discharged (released) outside the system, thereby allowing for improved environmental performance.

In the aforementioned drying system, it is preferable that a condenser or a cooler that condenses and captures moisture in the drying gas delivered from the drying device be provided at an intermediate portion of the pipe.

With such a drying system, since drying gas that is dry and has a low moisture content is supplied to the drying device, and this drying gas that is dry and has a low moisture content is used for drying the low-grade coal supplied to the drying device, the low-grade coal can be efficiently dried within a short period of time.

In the aforementioned drying system, it is preferable that a heater that heats the drying gas be provided at an intermediate portion of the pipe, the intermediate portion being located between the condenser or the cooler and the drying device.

With such a drying system, because the drying gas to be supplied to the drying device is heated by the heater, the low-grade coal can be dried more efficiently within a shorter period of time.

In the aforementioned drying system, it is preferable that a second heater that heats the drying gas be provided at an intermediate portion of the pipe, the intermediate portion being located between the cooler and the drying device. Moreover, it is preferable that the second heater and the cooler be connected with each other via a second pipe that forms a closed system independent of the closed system of the pipe and constitute a compression heat pump together with a compressor provided at an intermediate portion of the second pipe.

With such a drying system, the drying gas to be supplied to the drying device is heated by the second heater so that the temperature of the drying gas to be supplied to the drying device can be increased, whereby the low-grade coal can be dried more efficiently within a shorter period of time.

Because the cooler and the second heater constitute the compression heat pump, the heat captured in the cooler can be used for heating the drying gas in the second heater, thereby increasing the thermal efficiency of the system.

In the aforementioned drying system, it is preferable that a third heater that heats the drying gas be provided at an intermediate portion of the pipe, the intermediate portion being located between the cooler and the drying device. Moreover, it is preferable that the third heater and a second cooler that condenses and captures moisture in exhaust delivered from the coal pulverizer be connected with each other via a third pipe that forms a closed system independent of the closed systems of the pipe and the second pipe and constitute a second compression heat pump together with a second compressor provided at an intermediate portion of the third pipe.

With such a drying system, the drying gas to be supplied to the drying device is heated by the third heater so that the temperature of the drying gas to be supplied to the drying device can be increased, whereby the low-grade coal can be dried more efficiently within a shorter period of time.

Because the second cooler and the third heater constitute the compression heat pump, the heat captured in the second cooler can be used for heating the drying gas in the third heater, thereby increasing the thermal efficiency of the system.

In a steam generating plant according to an aspect of the present invention using low-grade coal as fuel and including the aforementioned drying system, a boiler that generates steam, a steam turbine that is driven by the steam, a condenser that captures the steam, after the steam has fulfilled its role in the steam turbine, and condenses the steam, and a coal pulverizer that pulverizes the low-grade coal to be supplied to the boiler into particles small enough that the low-grade coal can be used as fuel for the boiler, exhaust heat from the condenser is supplied to the heater so as to be used as a heat source for heating the drying gas.

With the steam generating plant according to the above aspect, the exhaust heat from the condenser, which is to be discharged outside the system in the related art after the exhaust heat has fulfilled its role in a steam cycle, is effectively used for drying the low-grade coal (such as lignite) serving as fuel for the boiler, so that heat (such as extracted steam) required for drying the fuel can be reduced, thereby increasing the thermal efficiency of the entire plant.

Since drying gas containing moisture when traveling through the drying device is prevented from being injected into the boiler together with the fuel, heat loss caused by moisture (i.e., latent heat) in the boiler can be reduced, thereby increasing the thermal efficiency of the entire plant.

In the aforementioned steam generating plant, it is preferable that a supply pipe that supplies inert gas and/or exhaust gas from the boiler be connected to an intermediate portion of the pipe.

With such a steam generating plant, the oxygen concentration (wet) in the drying gas can be reduced to below 13%, or preferably, to below 10%, so that natural oxidation and spontaneous combustion of the low-grade coal (such as lignite) can be prevented, thereby allowing for increased safety and reliability.

In the aforementioned steam generating plant, it is preferable that a pulverized-coal collector that collects dust from the pulverized coal be provided between the coal pulverizer and a pulverized-coal hopper to which the pulverized coal serving as fuel for the boiler is supplied.

With such a steam generating plant, the boiler is supplied only with the pulverized coal serving as fuel, but is not supplied with gas containing moisture or dust, so that heat loss caused by moisture (i.e., latent heat) in the boiler can be further reduced, thereby further increasing the thermal efficiency of the entire plant.

Since the gas undergoes a dust removal process in the pulverized-coal collector, clean gas is discharged (released) outside the system, thereby allowing for improved environmental performance.

In the aforementioned steam generating plant, it is preferable that exhaust delivered from the pulverized-coal collector be delivered to an electrostatic precipitator that collects dust in exhaust gas coming from the boiler, and be processed in the electrostatic precipitator.

With such a steam generating plant, since the gas undergoes a dust removal process in the pulverized-coal collector and then undergoes another dust removal process in the electrostatic precipitator, clean gas is discharged (released) outside the system, thereby further improving the environmental performance.

It is preferable that the aforementioned steam generating plant further include a moisture meter that detects moisture in the low-grade coal to be supplied to the coal pulverizer from the drying device, and a heat input level in the heater and/or the second heater and/or the third heater be set on the basis of a detection result obtained by the moisture meter.

In the aforementioned steam generating plant, because the moisture in the low-grade coal (the lignite) to be discharged from the drying device is maintained at a desired percentage by weight (e.g., about 20 percent by weight), natural oxidation and spontaneous combustion of the low-grade coal (such as lignite) from the drying device can be prevented within the coal pulverizer, thereby allowing for increased safety and reliability.

A thermal power plant using low-grade coal as fuel according to the present invention includes a steam generating plant having good thermal efficiency, thereby allowing for increased thermal efficiency of the entire thermal power plant that includes a power generating system.

### Advantageous Effects of Invention

The thermal power plant using low-grade coal as fuel according to the present invention advantageously allows for increased thermal efficiency of the entire plant.

### BRIEF DESCRIPTION OF DRAWINGS

FIG. 1 schematically illustrates the configuration of a lignite-fired thermal power plant according to a first embodiment of the present invention.

FIG. 2 schematically illustrates the configuration of a lignite-fired thermal power plant according to a second embodiment of the present invention.

FIG. 3 schematically illustrates the configuration of a lignite-fired thermal power plant according to a third embodiment of the present invention.

FIG. 4 schematically illustrates the configuration of a lignite-fired thermal power plant according to a fourth embodiment of the present invention.

FIG. 5 schematically illustrates the configuration of a lignite-fired thermal power plant according to a fifth embodiment of the present invention.

FIG. 6 schematically illustrates the configuration of a lignite-fired thermal power plant according to a sixth embodiment of the present invention.

FIG. 7 schematically illustrates the configuration of a lignite-fired thermal power plant according to a seventh embodiment of the present invention.

FIG. 8 schematically illustrates the configuration of a lignite-fired thermal power plant according to an eighth embodiment of the present invention.

FIG. 9 schematically illustrates the configuration of a lignite-fired thermal power plant according to a ninth embodiment of the present invention.

FIG. 10 schematically illustrates the configuration of a lignite drying system according to a first embodiment of the present invention.

FIG. 11 schematically illustrates the configuration of a lignite drying system according to a second embodiment of the present invention.

FIG. 12 schematically illustrates the configuration of a lignite drying system according to a third embodiment of the present invention.

FIG. 13 schematically illustrates the configuration of a lignite-fired thermal power plant according to a tenth embodiment of the present invention.

FIG. 14 schematically illustrates the configuration of a lignite-fired thermal power plant according to an eleventh embodiment of the present invention.

FIG. 15 schematically illustrates the configuration of a lignite-fired thermal power plant according to a twelfth embodiment of the present invention.

FIG. 16 schematically illustrates the configuration of a lignite-fired thermal power plant according to a thirteenth embodiment of the present invention.

FIG. 17 schematically illustrates the configuration of a lignite-fired thermal power plant according to a fourteenth embodiment of the present invention.

FIG. 18 schematically illustrates the configuration of a lignite-fired thermal power plant according to a fifteenth embodiment of the present invention.

FIG. 19 schematically illustrates the configuration of a lignite-fired thermal power plant according to a sixteenth embodiment of the present invention.

FIG. 20 schematically illustrates the configuration of a lignite-fired thermal power plant according to a seventeenth embodiment of the present invention.

FIG. 21 schematically illustrates the configuration of a lignite-fired thermal power plant according to an eighteenth embodiment of the present invention.

### DESCRIPTION OF EMBODIMENTS

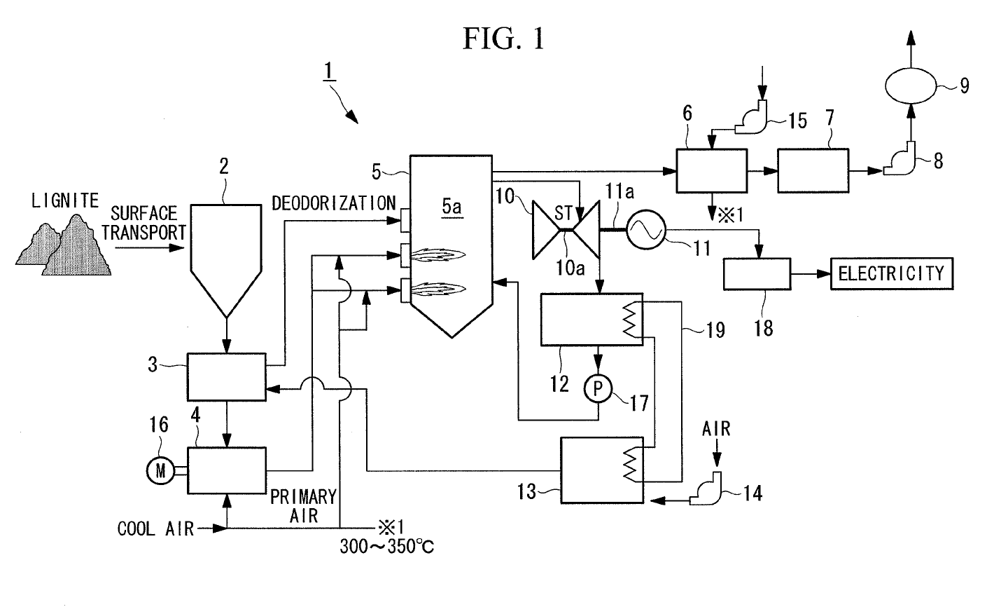

A first embodiment of a thermal power plant that uses low-grade coal as fuel (referred to as “lignite-fired thermal power plant” hereinafter) according to the present invention will be described below with reference to FIG. 1.

FIG. 1 schematically illustrates the configuration of the lignite-fired thermal power plant according to this embodiment.

As shown in FIG. 1, a lignite-fired thermal power plant 1 according to this embodiment mainly includes a storage silo 2, a drying device 3, a lignite mill 4, a boiler 5, an air preheater 6, an electrostatic precipitator 7, an induced draft fan 8, a smokestack 9, a steam turbine 10, a generator 11, a condenser (steam condenser) 12, and a drying-gas heater 13.

The storage silo 2 is a so-called coal bunker that temporarily stores (retains) lignite (raw lignite) that has been transported from a coal storage by a truck, a belt conveyor, or the like (not shown).

The drying device 3 removes moisture from (or dries) the lignite (raw lignite), which has a high moisture content (e.g., about 60% by weight), so as to change the lignite (raw lignite) with a high moisture content into lignite (raw lignite) with a low moisture content (e.g., about 20% by weight). The drying device 3 is supplied with warm air (primary drying air) that has been forced into the drying-gas heater 13 by a drying air fan 14 and has undergone heat exchange (i.e., has been heated) within the drying-gas heater 13, and this warm air removes the moisture from the lignite (i.e., dries the lignite). The cooled air used for removing the moisture from the lignite (i.e., for drying the lignite) is forced into the boiler 5 where the air is deodorized.

The lignite mill 4 is a so-called coal pulverizer that pulverizes the lignite with a low moisture content supplied from the drying device 3 into particles small enough that the lignite can be used as fuel for the boiler 5. The lignite mill 4 is supplied with warm air (secondary drying air) that has undergone heat exchange (i.e., has been heated) within the air preheater 6 after being forced into the air preheater 6 by an air-preheater air fan 15 and that has subsequently been mixed with cool air (room-temperature air), and this warm air further removes the moisture from the lignite (i.e., further dries the lignite) until the moisture in the lignite is substantially lower than or equal to, for example, inherent moisture (e.g., 20% by weight or lower). The drying air supplied to the dried and pulverized lignite and to the pulverizer (i.e., the cooled air used for removing the moisture from the lignite (i.e., for drying the lignite)) is forced into the boiler 5 from a burner together with the air from the air preheater (i.e., the air (300° C. to 350° C.) prior to being mixed with the cool air) so as to be used as combustion air.

Reference numeral 16 in FIG. 1 denotes a motor serving as a driving source for the lignite mill 4. The primary air to be supplied to the lignite mill 4 is mixed with the cool air so that the temperature at an outlet of the lignite mill 4 is equal to a predetermined temperature (e.g., 60° C. to 80° C.).

The lignite (i.e., combustion lignite) and the combustion air supplied to the boiler 5 are combusted within a boiler furnace 5a so that high-pressure, high-temperature steam is generated within an evaporation tube (not shown) constituting the boiler furnace 5a by the heat of combustion gas. The evaporation tube is supplied with steam condensate from the condenser 12 via a condensate pump 17, and the high-pressure, high-temperature steam generated within the evaporation tube is supplied to a turbine section of the steam turbine 10. The combustion gas used for generating the high-pressure, high-temperature steam becomes boiler exhaust gas and is led (sucked) downstream (i.e., toward the air preheater 6) by the induced draft fan 8 disposed downstream of the electrostatic precipitator 7. The combustion gas is then used for heating air traveling through the air preheater 6 and has dust removed therefrom by the electrostatic precipitator 7 disposed downstream of the air preheater 6. Subsequently, the combustion gas is released to the atmosphere via the induced draft fan 8 and the smokestack 9.

On the other hand, the high-pressure, high-temperature steam supplied to the turbine section of the steam turbine 10 causes turbine blades (not shown) constituting the turbine section of the steam turbine 10 to rotate a rotor shaft 10a constituting the steam turbine 10, and is subsequently guided to the condenser 12 so as to become condensed within the condenser 12. The rotor shaft 10a is coupled to a rotation shaft 11a of the generator 11, and this rotation shaft 11a is configured to rotate together with the rotor shaft 10a. Electric energy (i.e., electric power) obtained as the result of the rotation of the rotation shaft 11a is converted to a desired voltage via a transformer 18 and is subsequently supplied to ordinary homes and factories.

A heat exchanger 19 is disposed between the condenser 12 and the drying-gas heater 13. The heat exchanger 19 captures heat from the steam guided into the condenser 12 and applies the heat to air traveling through the drying-gas heater 13 so as to heat the air traveling through the drying-gas heater 13.

With the lignite-fired thermal power plant 1 according to this embodiment, the lignite (raw lignite) serving as fuel for the boiler 5 is dried by using exhaust heat from the condenser 12 so that heat loss caused by moisture (latent heat) in the boiler is reduced, thereby increasing the thermal efficiency of the entire plant.

Because the cooled air used for removing the moisture from the lignite (i.e., for drying the lignite) within the drying device 3 is forced into the boiler 5 so as to be used as combustion air, the air-preheater air fan 15 that forces the combustion air into the boiler 5 can be reduced in volume and made compact.

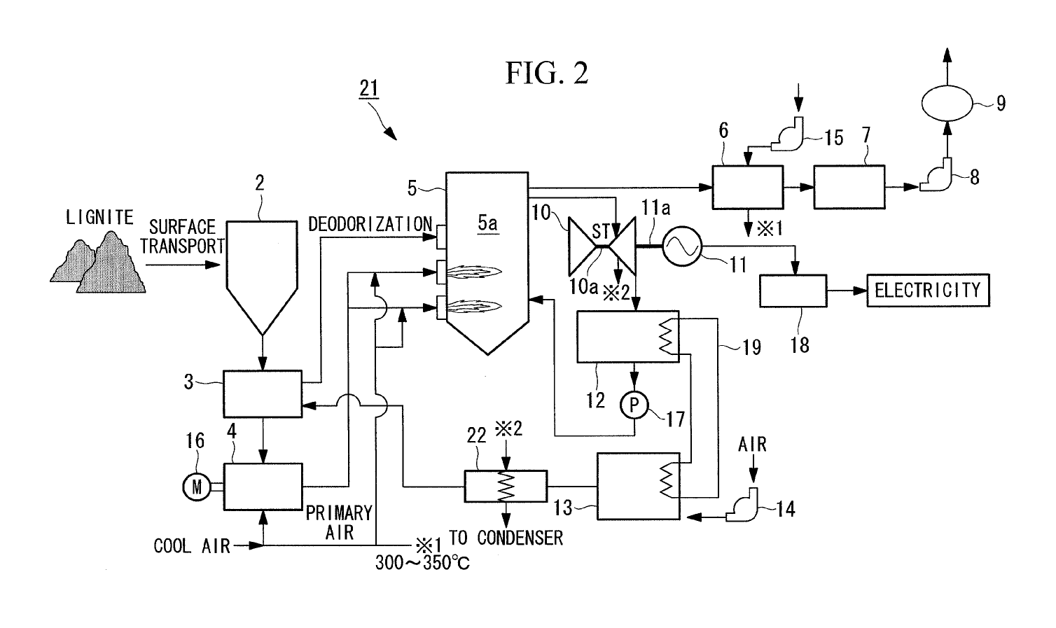

A second embodiment of a lignite-fired thermal power plant according to the present invention will now be described with reference to FIG. 2.

FIG. 2 schematically illustrates the configuration of the lignite-fired thermal power plant according to this embodiment.

A lignite-fired thermal power plant 21 according to this embodiment differs from that in the first embodiment described above in that it includes a heater 22. Since other components are the same as those in the first embodiment described above, descriptions of these components will be omitted here.

As shown in FIG. 2, the heater 22 is provided between the drying device 3 and the drying-gas heater 13 and is a heat exchanger that further heats the warm air (primary drying air) to be supplied to the drying device 3 from the drying-gas heater 13. The heater 22 is supplied with steam extracted from an intermediate portion of the turbine section of the steam turbine 10 (e.g., an intermediate portion of a low-pressure turbine constituting the turbine section of the steam turbine 10), and the warm air to be supplied to the drying device 3 from the drying-gas heater 13 is heated by the condensation heat of this steam. The cooled steam used for heating the warm air to be supplied to the drying device 3 from the drying-gas heater 13 is guided to the condenser 12 so as to become condensed within the condenser 12, and the steam condensed within the heater 22 is guided as drain-water to the condenser 12.

With the lignite-fired thermal power plant 21 according to this embodiment, the temperature of the air (primary drying air) to be supplied to the drying device 3 is higher than that in the first embodiment due to the heater 22, so that the flow rate of the air to be supplied to the drying device 3 can be reduced relative to that in the first embodiment, whereby the drying air fan 14 can be reduced in volume and made more compact, as compared with that in the first embodiment.

Because the diversion flow rate at which the temperature of the air to be supplied to the drying device 3 increases is lower than that in the first embodiment, and the drying efficiency of the drying device is increased, the drying device 3 can be reduced in volume and made more compact, as compared with that in the first embodiment.

Since other advantages are the same as those in the first embodiment described above, descriptions thereof will be omitted here.

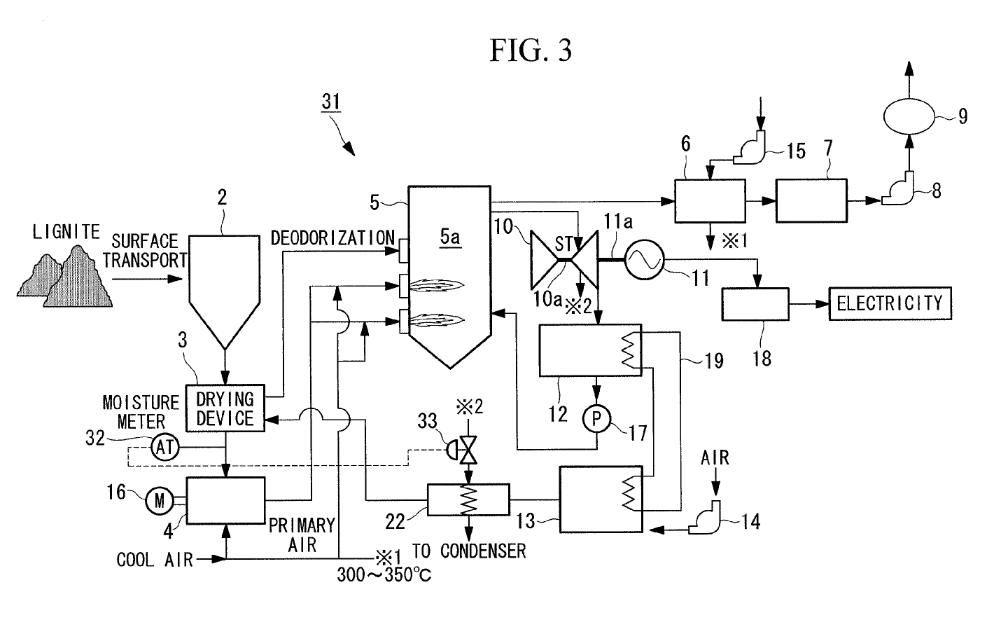

A third embodiment of a lignite-fired thermal power plant according to the present invention will now be described with reference to FIG. 3.

FIG. 3 schematically illustrates the configuration of the lignite-fired thermal power plant according to this embodiment.

A lignite-fired thermal power plant 31 according to this embodiment differs from that in the second embodiment described above in that it includes a moisture meter 32 and a flow control valve 33. Since other components are the same as those in the second embodiment described above, descriptions of these components will be omitted here.

As shown in FIG. 3, the moisture meter 32 detects the moisture in the lignite to be supplied to the lignite mill 4 from the drying device 3, and the detection result obtained by the moisture meter 32 is output to a controller (not shown) and is used as data for setting the degree of opening of the flow control valve 33.

The flow control valve 33 adjusts the flow rate of the steam to be supplied to the heater 22 from the intermediate portion of the turbine section of the steam turbine 10, and the degree of opening thereof is adjusted (controlled) by the aforementioned controller so that the moisture in the lignite to be supplied to the lignite mill 4 from the drying device 3 is, for example, about 20% by weight.

As an alternative to the technique of directly measuring the moisture in the low-grade coal, the moisture in the low-grade coal may be measured from the flow rate of and the moisture in the drying gas to be supplied to the drying device, the moisture in the coal, and the flow rate of and the moisture in the drying gas at the outlet of the drying device.

With the lignite-fired thermal power plant 31 according to this embodiment, the moisture in the lignite within the drying device 3 is maintained at about, for example, 20% by weight so that spontaneous combustion of the lignite within the drying device 3 can be prevented, thereby allowing for increased safety and reliability.

In addition, the amount of drying gas is adjustable in accordance with the initial moisture and dryness of the low-grade coal so that the drying power (of the fan) and the extraction steam flow rate (for the heater) can be reduced, thereby allowing for higher efficiency.

Since other advantages are the same as those in the second embodiment described above, descriptions thereof will be omitted here.

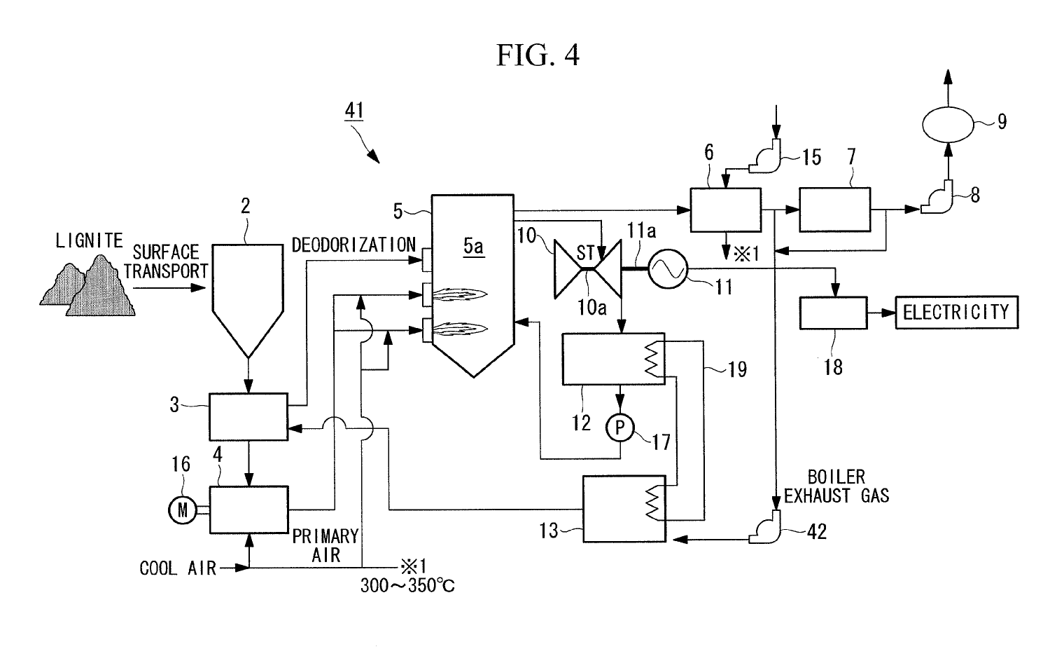

A fourth embodiment of a lignite-fired thermal power plant according to the present invention will now be described with reference to FIG. 4.

FIG. 4 schematically illustrates the configuration of the lignite-fired thermal power plant according to this embodiment.

A lignite-fired thermal power plant 41 according to this embodiment differs from that in the first embodiment described above in that it includes a drying exhaust-gas fan 42 in place of the drying air fan 14. Since other components are the same as those in the first embodiment described above, descriptions of these components will be omitted here.

As shown in FIG. 4, the drying exhaust-gas fan 42 is supplied with a portion of boiler exhaust gas guided to the electrostatic precipitator 7 from the air preheater 6 and/or a portion of boiler exhaust gas guided to the induced draft fan 8 from the electrostatic precipitator 7, and the ratio of the total flow rate of the boiler exhaust gas supplied to the drying exhaust-gas fan 42, the flow rate of the boiler exhaust gas guided to the drying exhaust-gas fan 42 from between the air preheater 6 and the electrostatic precipitator 7, and the flow rate of the boiler exhaust gas guided to the drying exhaust-gas fan 42 from between the electrostatic precipitator 7 and the induced draft fan 8 depends on (i.e., varies depending on) the temperature required (requested) by the drying device 3. The drying device 3 is supplied with warm boiler exhaust gas (primary drying exhaust gas) that has been forced into the drying-gas heater 13 by the drying exhaust-gas fan 42 and has undergone heat exchange (i.e., has been heated) within the drying-gas heater 13, and this warm boiler exhaust gas removes the moisture from the lignite (i.e., dries the lignite). The cooled boiler exhaust gas used for removing the moisture from the lignite (i.e., for drying the lignite) is forced into the boiler 5 where the boiler exhaust gas is deodorized.

With the lignite-fired thermal power plant 41 according to this embodiment, boiler exhaust gas with low oxygen concentration is used for removing the moisture from the lignite (i.e., for drying the lignite) so that natural oxidation and spontaneous combustion of the lignite within the drying device 3 can be prevented, thereby allowing for increased safety and reliability.

Since the boiler exhaust gas used in the drying device 3 has a temperature higher than that of the warm air (primary drying air) used in the first embodiment, the flow rate of the boiler exhaust gas to be supplied to the drying device 3 can be reduced relative to that in the first embodiment, whereby the drying air fan 14 can be reduced in volume and made more compact, as compared with that in the first embodiment.

If the flow rate of the boiler exhaust gas to be supplied to the drying device 3 is set to be the same as that of the warm air (primary drying air) used in the first embodiment, the drying device 3 can be reduced in volume and made more compact, as compared with that in the first embodiment.

The use of boiler exhaust gas with low oxygen concentration for removing the moisture from the lignite (i.e., for drying the lignite) allows for an increase in the thermal efficiency of the entire plant.

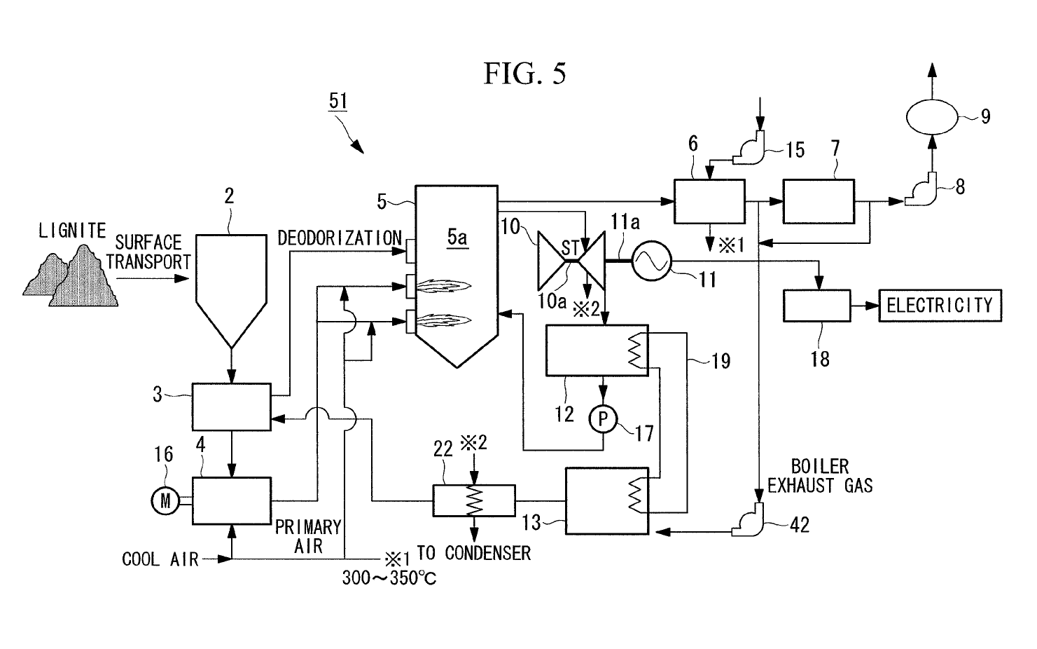

A fifth embodiment of a lignite-fired thermal power plant according to the present invention will now be described with reference to FIG. 5.

FIG. 5 schematically illustrates the configuration of the lignite-fired thermal power plant according to this embodiment.

A lignite-fired thermal power plant 51 according to this embodiment differs from that in the fourth embodiment described above in that it includes the heater 22 described in the second embodiment. Since other components are the same as those in the fourth embodiment described above, descriptions of these components will be omitted here.

With the lignite-fired thermal power plant 51 according to this embodiment, the temperature of the boiler exhaust gas (primary drying exhaust gas) to be supplied to the drying device 3 is higher than that in the fourth embodiment due to the heater 22, so that the flow rate of the boiler exhaust gas to be supplied to the drying device 3 can be reduced relative to that in the fourth embodiment, whereby the drying exhaust-gas fan 42 can be reduced in volume and made more compact, as compared with that in the fourth embodiment.

If the flow rate of the boiler exhaust gas to be supplied to the drying device 3 is set to be the same as that in the fourth embodiment, the drying device 3 can be reduced in volume and made more compact, as compared with that in the fourth embodiment.

Since other advantages are the same as those in the fourth embodiment described above, descriptions thereof will be omitted here.

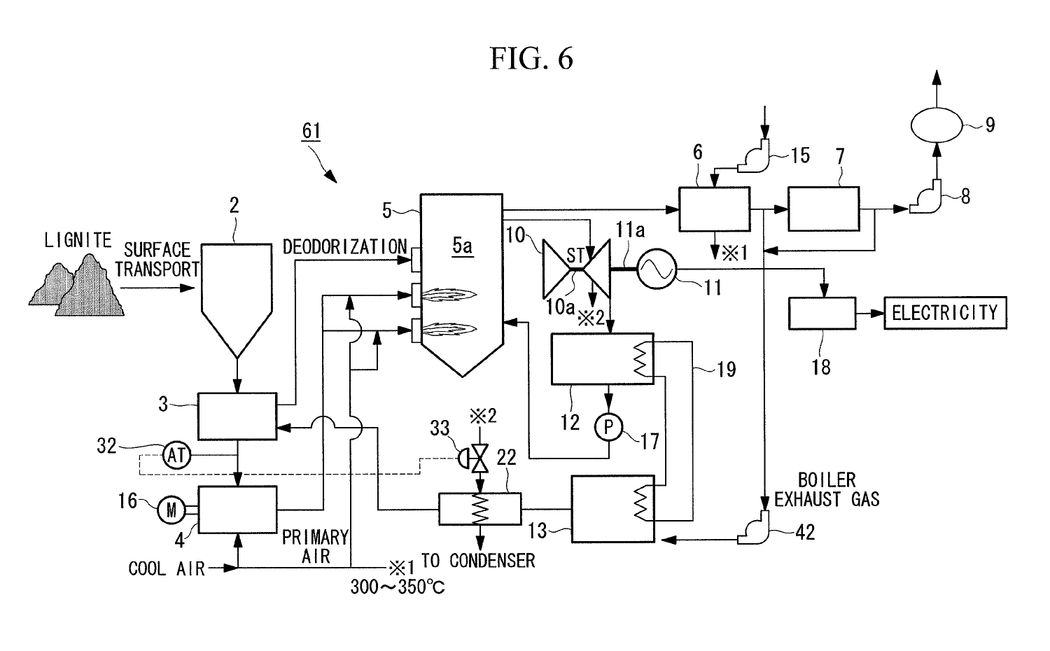

A sixth embodiment of a lignite-fired thermal power plant according to the present invention will now be described with reference to FIG. 6.

FIG. 6 schematically illustrates the configuration of the lignite-fired thermal power plant according to this embodiment.

A lignite-fired thermal power plant 61 according to this embodiment differs from that in the fifth embodiment described above in that it includes the moisture meter 32 and the flow control valve 33 described in the third embodiment. Since other components are the same as those in the fifth embodiment described above, descriptions of these components will be omitted here.

As an alternative to the technique of directly measuring the moisture in the low-grade coal, the moisture in the low-grade coal may be measured from the flow rate of and the moisture in the drying gas to be supplied to the drying device, the moisture in the coal, and the flow rate of and the moisture in the drying gas at the outlet of the drying device.

With the lignite-fired thermal power plant 61 according to this embodiment, the moisture in the lignite discharged from the drying device 3 is maintained at about, for example, 20% by weight so that spontaneous combustion of the lignite within the drying device 3 can be prevented, thereby allowing for increased safety and reliability.

Since other advantages are the same as those in the fifth embodiment described above, descriptions thereof will be omitted here.

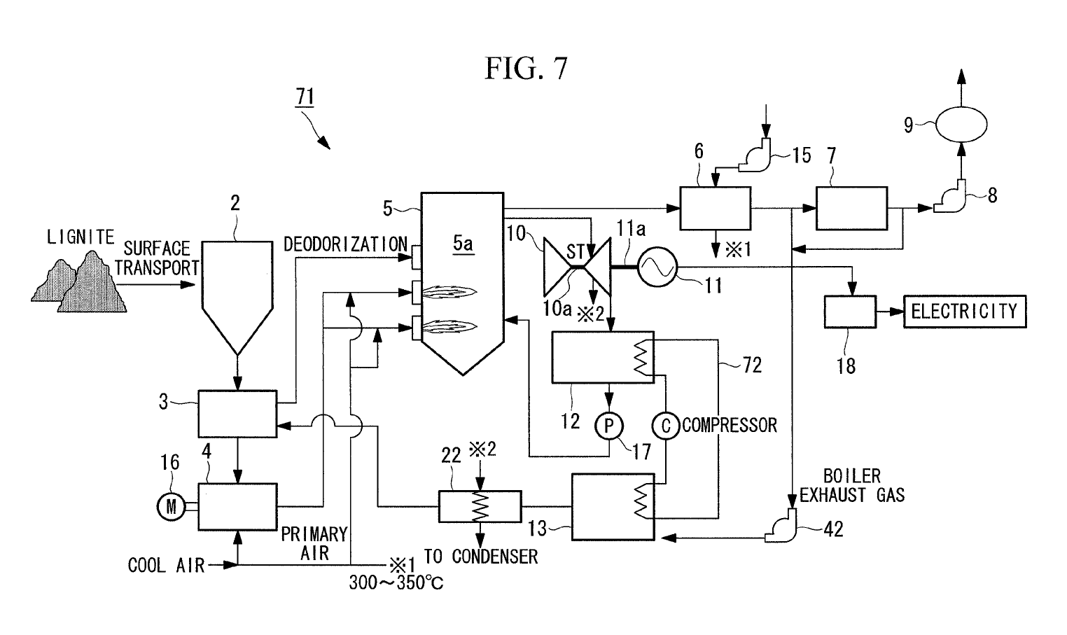

A seventh embodiment of a lignite-fired thermal power plant according to the present invention will now be described with reference to FIG. 7.

FIG. 7 schematically illustrates the configuration of the lignite-fired thermal power plant according to this embodiment.

A lignite-fired thermal power plant 71 according to this embodiment differs from that in the fifth embodiment described above in that it includes a compression heat pump 72, which uses ammonia, CO₂, or the like as a refrigerant, in place of the heat exchanger 19. Since other components are the same as those in the fifth embodiment described above, descriptions of these components will be omitted here.

With the lignite-fired thermal power plant 71 according to this embodiment, exhaust heat from the condenser 12 is transmitted to the drying-gas heater 13 via the compression heat pump 72, which has good thermal transmission efficiency, thereby increasing the thermal efficiency of the entire plant.

Because the temperature of the boiler exhaust gas (primary drying exhaust gas) to be supplied to the drying device 3 by the compression heat pump 72 is higher than that in the fifth embodiment, the flow rate of the boiler exhaust gas to be supplied to the drying device 3 can be reduced relative to that in the fifth embodiment, whereby the drying exhaust-gas fan 42 can be reduced in volume and made more compact, as compared with that in the fifth embodiment.

If the flow rate of the boiler exhaust gas to be supplied to the drying device 3 is set to be the same as that in the fifth embodiment, the drying device 3 can be reduced in volume and made more compact, as compared with that in the fifth embodiment.

Since other advantages are the same as those in the fifth embodiment described above, descriptions thereof will be omitted here.

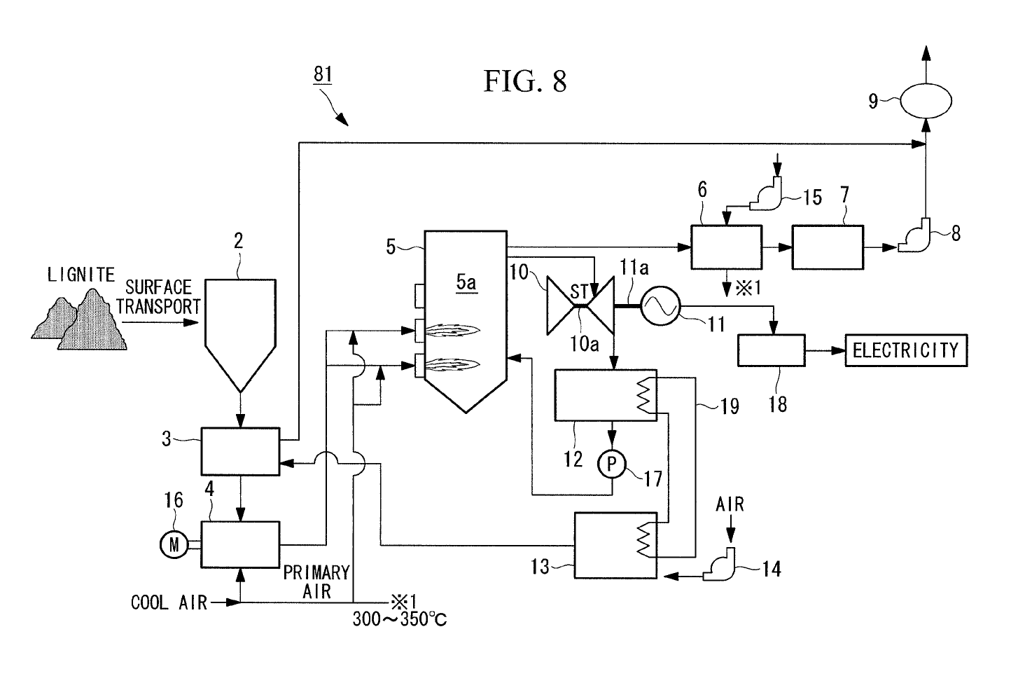

An eighth embodiment of a lignite-fired thermal power plant according to the present invention will now be described with reference to FIG. 8.

FIG. 8 schematically illustrates the configuration of the lignite-fired thermal power plant according to this embodiment.

A lignite-fired thermal power plant 81 according to this embodiment differs from that in the first embodiment described above in that the cooled air used for removing the moisture from the lignite (i.e., for drying the lignite) within the drying device 3 is guided between the induced draft fan 8 and the smokestack 9 and is released to the atmosphere via the smokestack 9 together with boiler exhaust gas guided to the smokestack 9 from the induced draft fan 8. Since other components are the same as those in the first embodiment described above, descriptions of these components will be omitted here.

With the lignite-fired thermal power plant 81 according to this embodiment, the cooled air used for removing the moisture from the lignite (i.e., for drying the lignite) does not need to be forced into the boiler 5, which has large resistance (specifically, the air is simply made to flow between the induced draft fan 8 and the smokestack 9 where the resistance is small), whereby the drying air fan 14 can be reduced in volume and made more compact, as compared with that in the first embodiment.

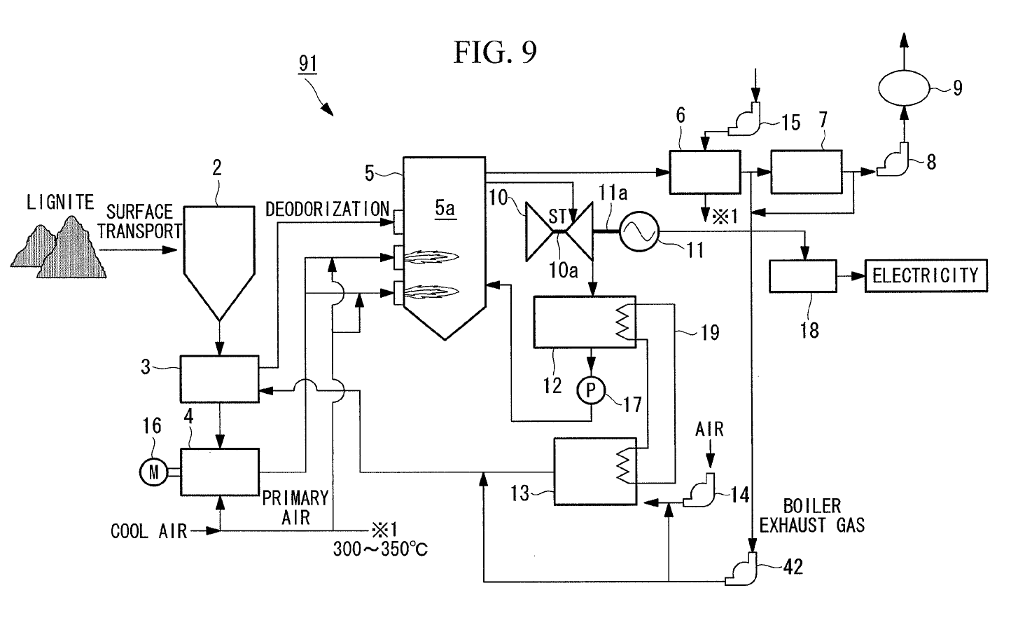

A ninth embodiment of a lignite-fired thermal power plant according to the present invention will now be described with reference to FIG. 9.

FIG. 9 schematically illustrates the configuration of the lignite-fired thermal power plant according to this embodiment.

A lignite-fired thermal power plant 91 according to this embodiment differs from that in the first embodiment described above in that it includes the drying exhaust-gas fan 42 described in the fourth embodiment. Since other components are the same as those in the first embodiment described above, descriptions of these components will be omitted here.

As shown in FIG. 9, the drying exhaust-gas fan 42 is supplied with a portion of boiler exhaust gas guided to the electrostatic precipitator 7 from the air preheater 6 and/or a portion of boiler exhaust gas guided to the induced draft fan 8 from the electrostatic precipitator 7, and the ratio of the total flow rate of the boiler exhaust gas supplied to the drying exhaust-gas fan 42, the flow rate of the boiler exhaust gas guided to the drying exhaust-gas fan 42 from between the air preheater 6 and the electrostatic precipitator 7, and the flow rate of the boiler exhaust gas guided to the drying exhaust-gas fan 42 from between the electrostatic precipitator 7 and the induced draft fan 8 depends on (i.e., varies depending on) the temperature required (requested) by the drying device 3. The boiler exhaust gas (primary drying exhaust gas) discharged from the drying exhaust-gas fan 42 is supplied to an intermediate portion of a pipe that connects the drying air fan 14 and the drying-gas heater 13 and to an intermediate portion of a pipe that connects the drying-gas heater 13 and the drying device 3. Then, the drying device 3 is supplied with warm air (primary drying air) that has been forced into the drying-gas heater 13 by the drying air fan 14 and has undergone heat exchange (i.e., has been heated) within the drying-gas heater 13, the warm boiler exhaust gas (primary drying exhaust gas) that has been forced into the drying-gas heater 13 by the drying exhaust-gas fan 42 and has undergone heat exchange (i.e., has been heated) within the drying-gas heater 13, and the warm boiler exhaust gas supplied to the intermediate portion of the pipe that connects the drying-gas heater 13 and the drying device 3 by the drying exhaust-gas fan 42, and the warm boiler exhaust gas and the warm air remove the moisture from the lignite (i.e., dry the lignite). The cooled boiler exhaust gas used for removing the moisture from the lignite (i.e., for drying the lignite) is forced into the boiler 5 where the boiler exhaust gas is deodorized.

With the lignite-fired thermal power plant 91 according to this embodiment, exhaust heat from the condenser 12 is used for drying the lignite (raw lignite) serving as fuel for the boiler 5, thereby increasing the thermal efficiency of the entire plant.

Because the cooled air and the cooled boiler exhaust gas used for removing the moisture from the lignite (i.e., for drying the lignite) within the drying device 3 are forced into the boiler 5 so as to be used as combustion air, the air-preheater air fan 15 for forcing the combustion air into the boiler 5 can be reduced in volume and made compact.

Since the boiler exhaust gas used in the drying device 3 has a temperature higher than that of the warm air (primary drying air) used in the first embodiment, the flow rate of the boiler exhaust gas to be supplied to the drying device 3 can be reduced relative to that in the first embodiment, whereby the drying air fan 14 can be reduced in volume and made more compact, as compared with that in the first embodiment.

If the flow rate of the boiler exhaust gas to be supplied to the drying device 3 is set to be the same as that of the warm air (primary drying air) used in the first embodiment, the drying device 3 can be reduced in volume and made more compact, as compared with that in the first embodiment.

The use of boiler exhaust gas with low oxygen concentration for removing the moisture from the lignite (i.e., for drying the lignite) allows for an increase in the thermal efficiency of the entire plant.

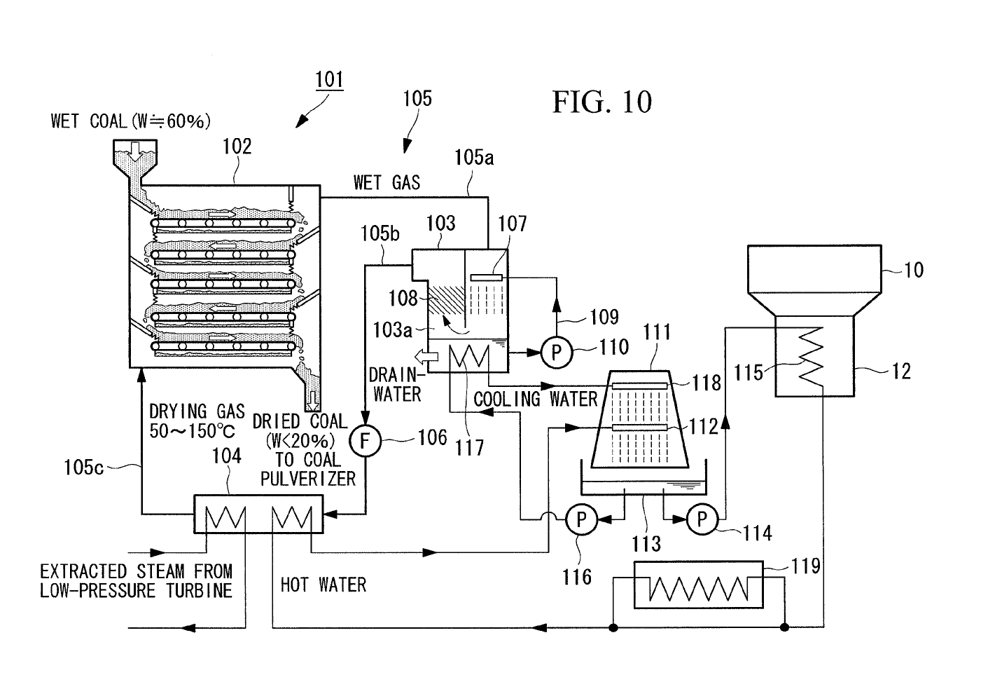

A first embodiment of a lignite drying system according to the present invention will be described below with reference to FIG. 10.

FIG. 10 schematically illustrates the configuration of the lignite drying system according to this embodiment.

As shown in FIG. 10, a lignite drying system 101 according to this embodiment mainly includes a drying device 102, a wet gas condenser 103, a drying-gas heater 104, pipework 105, and a drying-gas circulation fan 106.

The pipework 105 includes a first pipe 105a that guides wet gas delivered from the drying device 102 to the wet gas condenser 103, a second pipe 105b that guides drying gas delivered from the wet gas condenser 103 to the drying-gas heater 104, and a third pipe 105c that guides the drying gas with a high temperature (e.g., 50° C. to 150° C.) delivered from the drying-gas heater 104 to the drying device 102. The drying-gas circulation fan 106 is connected to an intermediate portion of the second pipe 105b, and drying gas discharged from a discharge port of the drying-gas circulation fan 106 is returned to an intake port of the drying-gas circulation fan 106 via the drying-gas heater 104, the drying device 102, and the wet gas condenser 103.

The drying device 102 removes moisture from (or dries) lignite (raw lignite), which has a high moisture content (e.g., about 60% by weight), so as to change the lignite (raw lignite) with a high moisture content into lignite (raw lignite) with a low moisture content (e.g., about 20% by weight). The drying device 102 is supplied with high-temperature drying gas that has been forced into the drying-gas heater 104 by the drying-gas circulation fan 106 and has undergone heat exchange (i.e., has been heated) within the drying-gas heater 104, and this high-temperature drying gas removes the moisture from the lignite (i.e., dries the lignite). The drying gas (wet gas) used for removing the moisture from the lignite (i.e., for drying the lignite) and reduced to a low temperature (e.g., 30° C. to 60° C.) is forced into the wet gas condenser 103 where the drying gas is processed.

The lignite dried in the drying device 102 is supplied to a lignite mill (pulverizer: coal pulverizer) 4 that pulverizes the lignite into particles small enough that, for example, the lignite can be used as fuel for the boiler 5 shown in FIG. 1.

A flow passage 103a that downwardly guides the wet gas flowing from the top surface of the wet gas condenser 103 via the first pipe 105a and then guides the wet gas toward an upper portion (top portion) of a side surface of the wet gas condenser 103 connected with one end (i.e., upstream end) of the second pipe 105b is formed inside the wet gas condenser 103. A spray cooler 107 is provided at an upstream side of the flow passage 103a, and a demister 108 is provided at a downstream side of the flow passage 103a.

The spray cooler 107 and the bottom of the wet gas condenser 103 are connected (i.e., are in communication) with each other via a pipe 109, and a feed pump 110 is connected to an intermediate portion of the pipe 109. Thus, drain-water accumulated at the bottom of the wet gas condenser 103 is sprayed from the spray cooler 107, and the moisture in the wet gas traveling through the flow passage 103a is condensed so as to become accumulated as drain-water at the bottom of the wet gas condenser 103.

The drain-water accumulated at the bottom of the wet gas condenser 103 is regularly discharged via a drainage outlet tube (not shown).

From drying gas from which moisture has been removed by the spray cooler 107, the demister 108 captures lignite particles and dust mixed during the lignite drying process within the drying device 102.

The drying-gas heater 104 heats the drying gas traveling therethrough by using, for example, extracted steam from a low-pressure turbine (not shown) of a steam turbine 10 and/or hot water that has undergone heat exchange (i.e., has been heated) when traveling through a condenser (steam condenser) 12. The extracted steam supplied from the low-pressure turbine is returned to the low-pressure turbine, whereas the hot water supplied from the condenser 12 is supplied to a spray cooler 112 disposed at a lower level inside an air cooling tower 111.

The hot water sprayed from the spray cooler 112 is cooled by air that fills (or is supplied to) the interior of the air cooling tower 111, and is accumulated as drain-water within a drain pan 113 provided at the bottom of the air cooling tower 111. The drain-water accumulated within the drain pan 113 is supplied to a heat transfer pipe 115 disposed inside the condenser 12 via a feed pump 114 or to a heat transfer pipe 117 disposed inside the wet gas condenser 103 via a feed pump 116.

The heat transfer pipe 117 is immersed in the drain-water accumulated at the bottom of the wet gas condenser 103, and the drain-water accumulated at the bottom of the wet gas condenser 103 is cooled by cooling water (i.e., drain-water) traveling through the heat transfer pipe 117. The cooling water traveling through the heat transfer pipe 117 is supplied to a spray cooler 118 disposed at an upper level inside the air cooling tower 111.

The cooling water sprayed from the spray cooler 118 is cooled by the air that fills (or is supplied to) the interior of the air cooling tower 111, and is accumulated as drain-water within the drain pan 113 provided at the bottom of the air cooling tower 111.

Reference numeral 119 in FIG. 10 denotes a boiler-exhaust-gas heat exchanger that heats the hot water to be supplied to the drying-gas heater 104 from the condenser 12 by using, for example, exhaust heat from the boiler 5 shown in FIG. 1.

With the lignite drying system 101 according to this embodiment, since the drying gas circulates within a closed system, the oxygen concentration in the drying gas can be reduced to below 13%, or preferably, to below 10%, so that natural oxidation and spontaneous combustion of the lignite can be prevented, thereby allowing for increased safety and reliability.

The lignite particles and dust mixed during the lignite drying process within the drying device 102 can be prevented from being discharged (released) outside the system, thereby allowing for improved environmental performance.

Since drying gas that is dry and has a low moisture content is supplied to the drying device 102, and this drying gas that is dry and has a low moisture content is used for drying the lignite supplied to the drying device 102, the lignite can be efficiently dried within a short period of time.

The drying gas to be supplied to the drying device 102 is heated by the heater 104, where the drying gas to be supplied to the drying device 102 is further heated, whereby the lignite can be dried more efficiently within a shorter period of time.

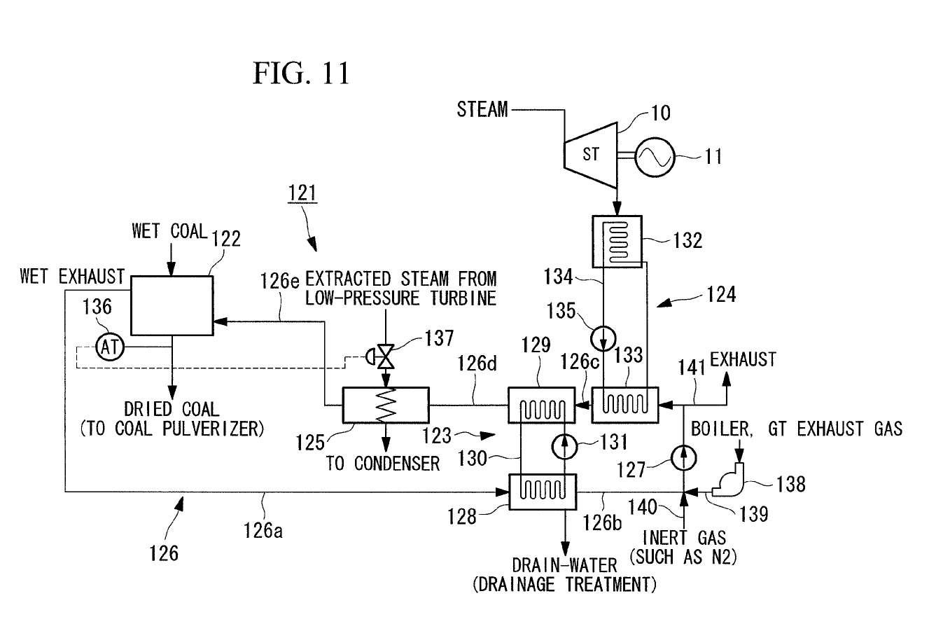

A second embodiment of a lignite drying system according to the present invention will now be described with reference to FIG. 11.

FIG. 11 schematically illustrates the configuration of the lignite drying system according to this embodiment.

As shown in FIG. 11, a lignite drying system 121 according to this embodiment mainly includes a drying device 122, a first compression heat pump 123, a second compression heat pump 124, a heater 125, pipework 126, and a drying-gas circulation fan 127.

The first compression heat pump 123 includes a cooler (heat absorber) 128, a heater (heat radiator) 129, a pipe 130 that forms a closed circuit between the cooler 128 and the heater 129, and a compressor 131 that is connected to an intermediate portion of the pipe 130 and that circulates a refrigerant (e.g., hydrofluorocarbon (HFC), i-pentane, NH₃, CO₂, or the like) filling the interior of the pipe 130.

The second compression heat pump 124 includes a cooler (heat absorber) 132, a heater (heat radiator) 133, a pipe 134 that forms a closed circuit between the cooler 132 and the heater 133, and a compressor 135 that is connected to an intermediate portion of the pipe 134 and that circulates a refrigerant (e.g., hydrofluorocarbon (HFC), i-pentane, NH₃, CO₂, or the like) filling the interior of the pipe 134.

In this embodiment, a condenser (steam condenser) 12 functions as the cooler 132.

The pipework 126 includes a first pipe 126a that guides wet gas delivered from the drying device 122 to the cooler 128, a second pipe 126b that guides drying gas delivered from the cooler 128 to the heater 133, a third pipe 126c that guides the drying gas (with a temperature between, for example, 20° C. and 50° C.) delivered from the heater 133 to the heater 129, a fourth pipe 126d that guides the drying gas (with a temperature between, for example, 30° C. and 90° C.) delivered from the heater 129 to the heater 125, and a fifth pipe 126e that guides the drying gas with a high temperature (e.g., 50° C. to 100° C.) delivered from the heater 125 to the drying device 122. The drying-gas circulation fan 127 is connected to an intermediate portion of the second pipe 126b, and drying gas discharged from a discharge port of the drying-gas circulation fan 127 is returned to an intake port of the drying-gas circulation fan 127 via the heater 133, the heater 129, the heater 125, the drying device 122, and the cooler 128.

The drying device 122 removes moisture from (or dries) lignite (raw lignite), which has a high moisture content (e.g., about 60% by weight), so as to change the lignite (raw lignite) with a high moisture content into lignite (raw lignite) with a low moisture content (e.g., about 20% by weight). The drying device 122 is supplied with high-temperature drying gas that has been sequentially forced into the heaters 133, 129, and 125 by the drying-gas circulation fan 127 and has undergone heat exchange (i.e., has been heated) within the heater 125, and this high-temperature drying gas removes the moisture from the lignite (i.e., dries the lignite). The drying gas (wet gas) used for removing the moisture from the lignite (i.e., for drying the lignite) and reduced to a low temperature (e.g., 30° C. to 60° C.) is forced into the cooler 128 where the drying gas is processed.

The lignite (dried coal) dried in the drying device 122 is supplied to a lignite mill (pulverizer: coal pulverizer) 4 that pulverizes the lignite into particles small enough that, for example, the lignite can be used as fuel for the boiler 5 shown in FIG. 1.

In the cooler 128, the heat of the wet gas is captured by the refrigerant traveling through the pipe 130, and the moisture in the wet gas is condensed so as to become accumulated as drain-water at the bottom of the cooler 128.

The drain-water accumulated at the bottom of the cooler 128 is discharged via a drainage outlet tube (not shown).

The heat captured by the refrigerant is used for heating (warming) the drying gas traveling through the heater 129.

On the other hand, in the cooler 132, the heat of steam discharged from a steam turbine 10 is captured by the refrigerant traveling through the pipe 134, so that the steam becomes condensed and accumulated at the bottom of the cooler 132.

The steam condensate accumulated at the bottom of the cooler 132 is supplied to, for example, the boiler 5 shown in FIG. 1 via a feed pipe (not shown).

The heat captured by the refrigerant is used for heating (warming) the drying gas traveling through the heater 133.

The heater 125, which is provided between the heater 129 and the drying device 122, is a heat exchanger that further heats the drying gas to be supplied to the drying device 122 from the heater 129. The heater 125 is supplied with steam extracted from an intermediate portion of the turbine section of the steam turbine 10 (e.g., an intermediate portion of a low-pressure turbine constituting the turbine section of the steam turbine 10), and the drying gas to be supplied to the drying device 122 from the heater 129 is heated by the condensation heat of this steam. The cooled steam used for heating the drying gas to be supplied to the drying device 122 from the heater 129 is guided to the condenser 12 so as to become condensed within the condenser 12.

Reference numeral 136 in FIG. 11 denotes a moisture meter, and reference numeral 137 denotes a flow control valve.

The moisture meter 136 detects the moisture in the lignite discharged from the drying device 122 to be supplied to, for example, the lignite mill 4 shown in FIG. 1, and the detection result obtained by the moisture meter 136 is output to a controller (not shown) so as to be used as data for setting the degree of opening of the flow control valve 137.

The flow control valve 137 adjusts the flow rate of the steam to be supplied to the heater 125 from the intermediate portion of the turbine section of the steam turbine 10, and the degree of opening thereof is adjusted (controlled) by the aforementioned controller so that the moisture in the lignite to be supplied to the lignite mill 4 from the drying device 122 is, for example, about 20% by weight.

As an alternative to the technique of directly measuring the moisture in the low-grade coal, the moisture in the low-grade coal may be measured from the flow rate of and the moisture in the drying gas to be supplied to the drying device, the moisture in the coal, and the flow rate of and the moisture in the drying gas at the outlet of the drying device.

Reference numeral 138 in FIG. 11 denotes a drying gas fan.

The drying gas fan 138 is supplied with, for example, a portion of boiler exhaust gas guided to the electrostatic precipitator 7 from the air preheater 6 shown in FIG. 6 and/or a portion of boiler exhaust gas guided to the induced draft fan 8 from the electrostatic precipitator 7, and drying gas delivered from the drying gas fan 138 flows into the second pipe 126b, located upstream of the drying-gas circulation fan 127, via a feed pipe (supply pipe) 139 and circulates within the pipework 126 together with the drying gas circulating within the pipework 126.

The second pipe 126b located upstream of the drying-gas circulation fan 127 can be supplied with inert gas (e.g., N₂) via a feed pipe (supply pipe) 140.

On the other hand, an exhaust pipe (discharge pipe) 141 is connected to an intermediate portion of the second pipe 126b located downstream of the drying-gas circulation fan 127, so that the drying gas circulating within the pipework 126 can be discharged, where appropriate.

With the lignite drying system 121 according to this embodiment, the drying gas to be supplied to the drying device 122 is heated by the heater (second heater) 129, where the drying gas to be supplied to the drying device 122 is further heated, whereby the lignite can be dried more efficiently within a shorter period of time.

Because the cooler 128 and the heater 129 constitute the first compression heat pump (compression heat pump) 123, the heat captured in the cooler 128 is used for heating the drying gas in the heater 129, thereby increasing the thermal efficiency of the system.

Since other advantages are the same as those in the first embodiment described above, descriptions thereof will be omitted here.

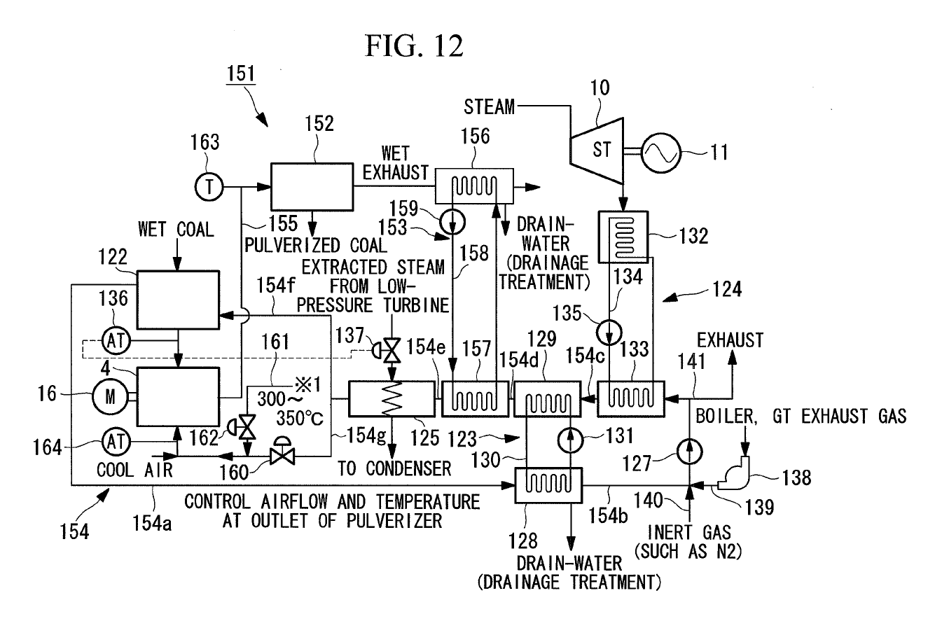

A third embodiment of a lignite drying system according to the present invention will now be described with reference to FIG. 12.

FIG. 12 schematically illustrates the configuration of the lignite drying system according to this embodiment.

A lignite drying system 151 according to this embodiment differs from that in the second embodiment described above in that it includes, for example, the lignite mill (pulverizer: coal pulverizer) 4 shown in FIG. 1, a pulverized-coal collector 152, and a third compression heat pump 153, and that it includes pipework 154 in place of the pipework 126. Since other components are the same as those in the second embodiment described above, descriptions of these components will be omitted here.

Reference numeral 16 in FIG. 12 denotes a motor serving as a driving source for the lignite mill 4.

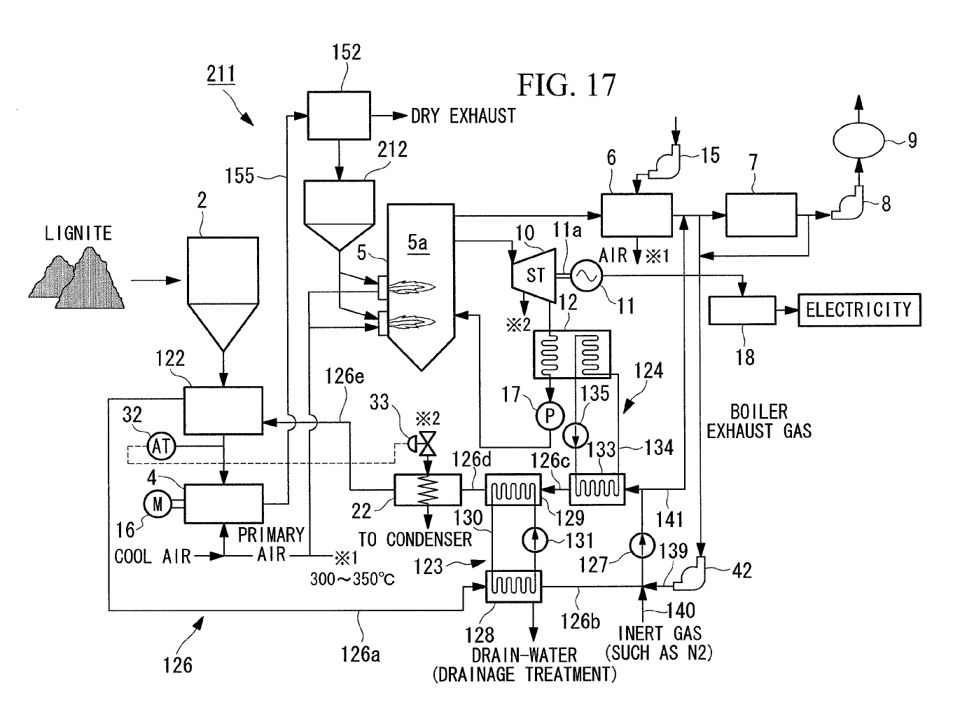

The pulverized-coal collector 152 separates drying gas and pulverized coal, delivered from the lignite mill 4 via a pipe 155, from each other and collects the pulverized coal. The separated and collected pulverized coal is delivered to the boiler 5 (see FIG. 1) via a pulverized-coal hopper (bin) 212 (not shown) (see FIG. 17) for storing the pulverized coal, and wet exhaust from which dust and the like are removed is delivered to a cooler 156 that constitutes the third compression heat pump 153.

The third compression heat pump 153 includes the cooler (heat absorber) 156, a heater (heat radiator) 157, a pipe 158 that forms a closed circuit between the cooler 156 and the heater 157, and a compressor 159 that is connected to an intermediate portion of the pipe 158 and that circulates a refrigerant (e.g., hydrofluorocarbon (HFC), i-pentane, NH₃, CO₂, or the like) filling the interior of the pipe 158.

The pipework 154 includes a first pipe 154a that guides wet gas delivered from the drying device 122 to the cooler 128, a second pipe 154b that guides drying gas delivered from the cooler 128 to the heater 133, a third pipe 154c that guides the drying gas (with a temperature between, for example, 20° C. and 50° C.) delivered from the heater 133 to the heater 129, a fourth pipe 154d that guides the drying gas (with a temperature between, for example, 30° C. and 90° C.) delivered from the heater 129 to the heater 157, a fifth pipe 154e that guides the drying gas with a high temperature (e.g., 50° C. to 100° C.) delivered from the heater 157 to the heater 125, a sixth pipe 154f that guides the drying gas with a high temperature (e.g., 50° C. to 150° C.) delivered from the heater 125 to the drying device 122, and a seventh pipe 154g that guides a portion of the drying gas with a high temperature (e.g., 50° C. to 150° C.) diverted from an intermediate portion of the sixth pipe 154f and delivered from the heater 125 toward the lignite mill 4. A drying-gas circulation fan 127 is connected to an intermediate portion of the second pipe 154b, and drying gas discharged from a discharge port of the drying-gas circulation fan 127 is returned to an intake port of the drying-gas circulation fan 127 via the heater 133, the heater 129, the heater 157, the heater 125, the drying device 122, and the cooler 128.

In the cooler 156, the heat of the wet exhaust is captured by the refrigerant traveling through the pipe 158, and the moisture in the wet exhaust is condensed so as to become accumulated as drain-water at the bottom of the cooler 156.

The drain-water accumulated at the bottom of the cooler 156 is discharged via a drainage outlet tube (not shown).

The heat captured by the refrigerant is used for heating (warming) the drying gas traveling through the heater 157.

A flow control valve 160 is connected to an intermediate portion of the seventh pipe 154g, and a pipe 161 that guides, for example, air that has undergone heat exchange in the air preheater 6 shown in FIG. 1 and exhaust gas delivered from a gas turbine (not shown) into the seventh pipe 154g is connected to an intermediate portion of the seventh pipe 154g located downstream of the flow control valve 160. A flow control valve 162 is connected to an intermediate portion of the pipe 161.

Reference numeral 163 in FIG. 12 denotes a thermometer that detects the temperature of the pulverized coal to be supplied to the pulverized-coal collector 152 from the lignite mill 4, and reference numeral 164 denotes an oxygen meter that detects the oxygen concentration in drying gas flowing from the lignite mill 4 and used for removing moisture from the pulverized coal (i.e., for drying the pulverized coal).

With the lignite drying system 151 according to this embodiment, the drying gas to be supplied to the drying device 122 is heated by the heater (third heater) 157, where the drying gas to be supplied to the drying device 122 is further heated, whereby the lignite can be dried more efficiently within a shorter period of time.

Because the cooler (second cooler) 156 and the heater (third cooler) 157 constitute the third compression heat pump (second compression heat pump) 153, the heat captured in the cooler 156 is used for heating the drying gas in the heater 157, thereby increasing the thermal efficiency of the system.

Since other advantages are the same as those in the first embodiment and the second embodiment described above, descriptions thereof will be omitted here.

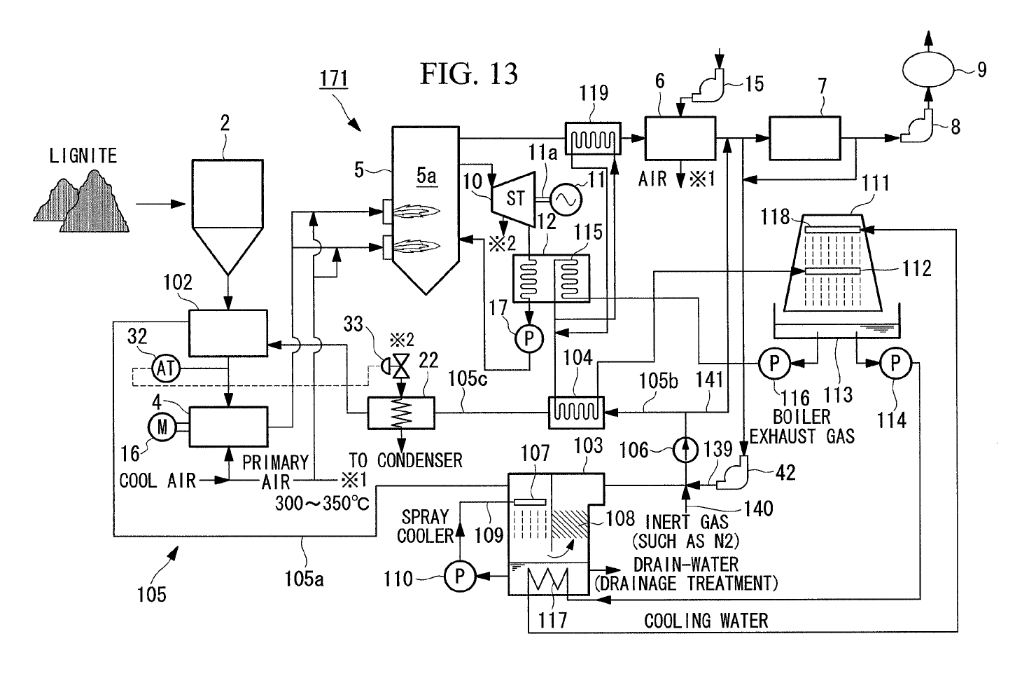

A tenth embodiment of a lignite-fired thermal power plant according to the present invention will now be described with reference to FIG. 13.

FIG. 13 schematically illustrates the configuration of the lignite-fired thermal power plant according to this embodiment.

A lignite-fired thermal power plant 171 according to this embodiment differs from that in the sixth embodiment described above in that it includes the drying device 102, the wet gas condenser 103, the drying-gas heater 104, the pipework 105, and the drying-gas circulation fan 106 described above with reference to FIG. 10 in place of the drying device 3 and the drying-gas heater 13. Since other components are the same as those in the sixth embodiment described above, descriptions of these components will be omitted here.

With the lignite-fired thermal power plant 171 according to this embodiment, exhaust heat from the condenser 12, which is to be discharged outside the system in the related art after the exhaust heat has fulfilled its role in a steam cycle, is effectively used for drying the lignite serving as fuel for the boiler 5, so that heat loss caused by moisture (i.e., latent heat) in the boiler 5 is reduced, thereby increasing the thermal efficiency of the entire plant.

Since drying gas containing moisture when traveling through the drying device 102 is prevented from being injected into the boiler 5 together with the fuel, heat loss caused by moisture (i.e., latent heat) in the boiler 5 can be reduced, thereby increasing the thermal efficiency of the entire plant.

Since feed pipes (supply pipes) 139 and 140 that supply exhaust gas from the boiler 5 and inert gas are connected to intermediate portions of the second pipe 105b, the oxygen concentration in the drying gas can be reduced to below 13%, or preferably, to below 10%, so that natural oxidation and spontaneous combustion of the lignite can be prevented, thereby allowing for increased safety and reliability.

Since the drying gas circulates within a closed system, the oxygen concentration in the drying gas can be reduced to below 13%, or preferably, to below 10%, so that natural oxidation and spontaneous combustion of the lignite can be prevented, thereby allowing for increased safety and reliability.

Lignite particles and dust mixed during the lignite drying process within the drying device 102 can be prevented from being discharged (released) outside the system, thereby allowing for improved environmental performance.

Since drying gas that is dry and has a low moisture content is supplied to the drying device 102, and this drying gas that is dry and has a low moisture content is used for drying the lignite supplied to the drying device 102, the lignite can be efficiently dried within a short period of time.

The drying gas to be supplied to the drying device 102 is heated by the heater 104, where the drying gas to be supplied to the drying device 102 is further heated, whereby the lignite can be dried more efficiently within a shorter period of time.

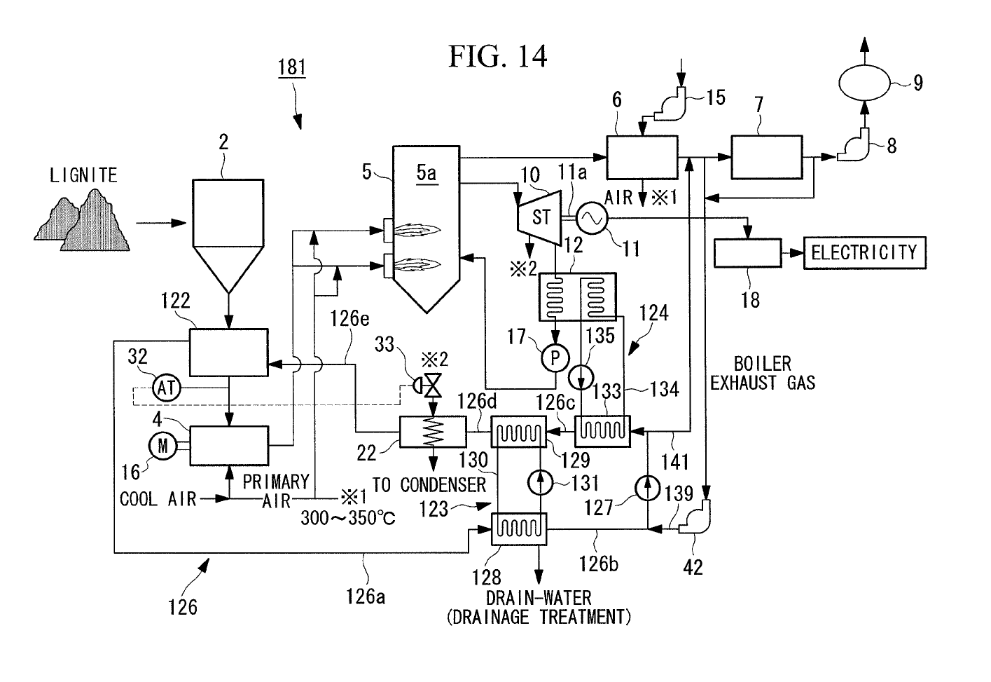

An eleventh embodiment of a lignite-fired thermal power plant according to the present invention will now be described with reference to FIG. 14.

FIG. 14 schematically illustrates the configuration of the lignite-fired thermal power plant according to this embodiment.

A lignite-fired thermal power plant 181 according to this embodiment differs from that in the sixth embodiment described above in that it includes the drying device 122, the first compression heat pump 123, the second compression heat pump 124, the pipework 126, and the drying-gas circulation fan 127 described above with reference to FIG. 11 in place of the drying device 3 and the drying-gas heater 13. Since other components are the same as those in the sixth embodiment described above, descriptions of these components will be omitted here.

With the lignite-fired thermal power plant 181 according to this embodiment, since a feed pipe (supply pipe) 139 that supplies exhaust gas from the boiler 5 is connected to an intermediate portion of the second pipe 126b, the oxygen concentration in the drying gas can be reduced to below 13%, or preferably, to below 10%, so that natural oxidation and spontaneous combustion of the lignite can be prevented, thereby allowing for increased safety and reliability.

The drying gas to be supplied to the drying device 122 is heated by the heater (second heater) 129, where the drying gas to be supplied to the drying device 122 is further heated, whereby the lignite can be dried more efficiently within a shorter period of time.

Because the cooler 128 and the heater 129 constitute the first compression heat pump (compression heat pump) 123, the heat captured in the cooler 128 is used for heating the drying gas in the heater 129, thereby increasing the thermal efficiency of the system.

Since other advantages are the same as those in the tenth embodiment described above, descriptions thereof will be omitted here.

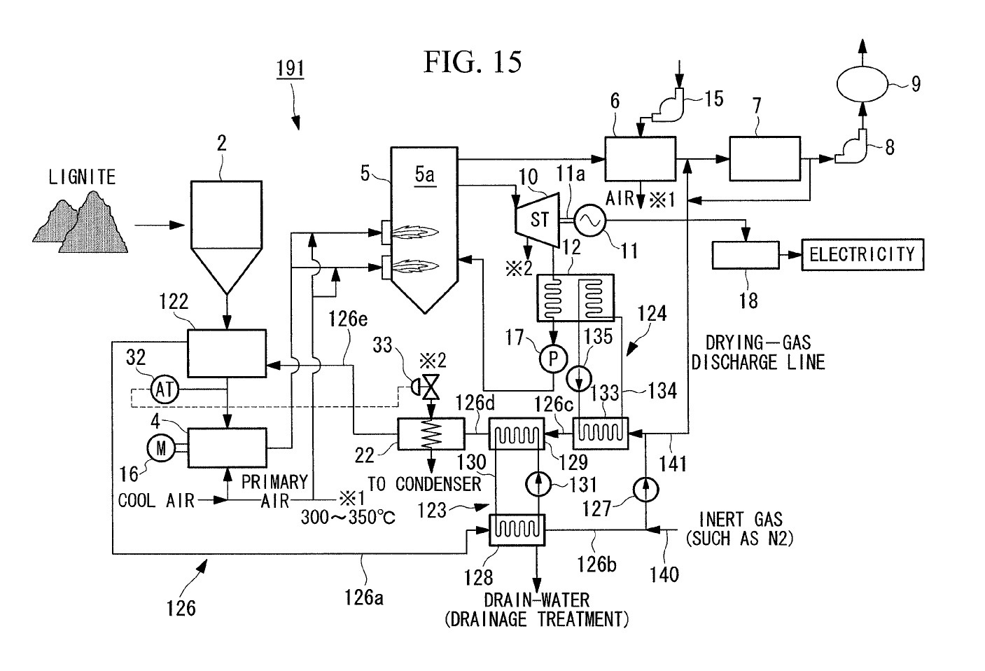

A twelfth embodiment of a lignite-fired thermal power plant according to the present invention will now be described with reference to FIG. 15.

FIG. 15 schematically illustrates the configuration of the lignite-fired thermal power plant according to this embodiment.

A lignite-fired thermal power plant 191 according to this embodiment differs from that in the eleventh embodiment described above in that a feed pipe (supply pipe) 140 that introduces (supplies) inert gas (e.g., N₂) into the second pipe 126b is provided in place of the drying gas fan 127 and the feed (supply) pipe 140 that introduce (supply) a portion of boiler exhaust gas, guided to the electrostatic precipitator 7 from the air preheater 6, and/or a portion of boiler exhaust gas, guided to the induced draft fan 8 from the electrostatic precipitator 7, into the second pipe 126b. Since other components are the same as those in the eleventh embodiment described above, descriptions of these components will be omitted here.

With the lignite-fired thermal power plant 191 according to this embodiment, since the feed pipe (supply pipe) 140 that supplies inert gas is connected to an intermediate portion of the second pipe 126b, the oxygen concentration in the drying gas can be reduced to below 13%, or preferably, to below 10%, so that natural oxidation and spontaneous combustion of the lignite can be prevented, thereby allowing for increased safety and reliability.

The drying gas to be supplied to the drying device 122 is heated by the heater (second heater) 129, where the drying gas to be supplied to the drying device 122 is further heated, whereby the lignite can be dried more efficiently within a shorter period of time.

Because the cooler 128 and the heater 129 constitute the first compression heat pump (compression heat pump) 123, the heat captured in the cooler 128 is used for heating the drying gas in the heater 129, thereby increasing the thermal efficiency of the system.

Since other advantages are the same as those in the tenth embodiment described above, descriptions thereof will be omitted here.

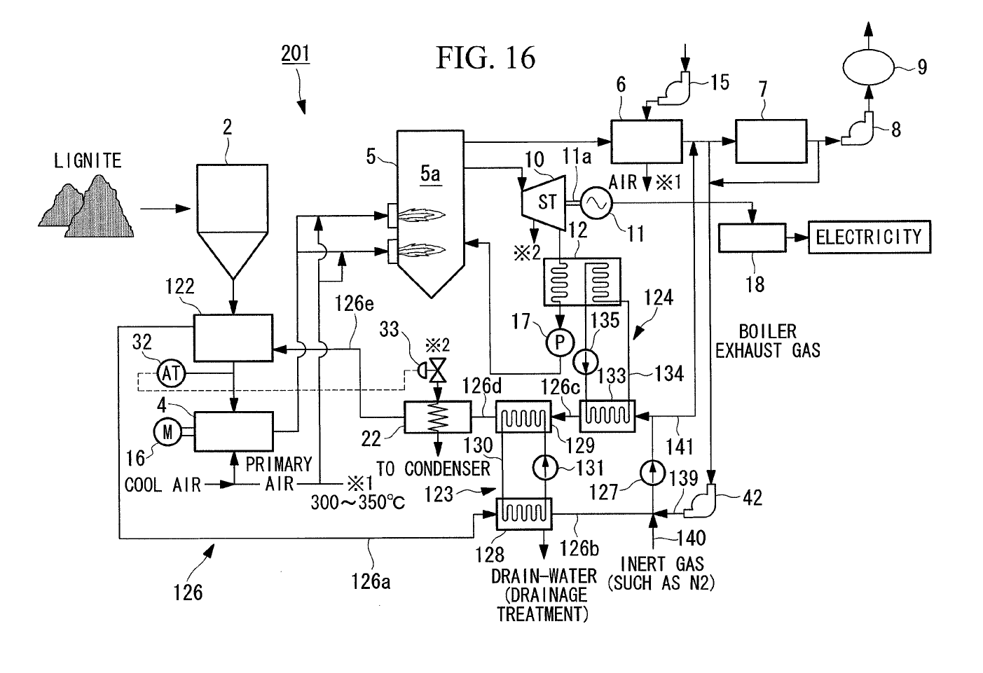

A thirteenth embodiment of a lignite-fired thermal power plant according to the present invention will now be described with reference to FIG. 16.

FIG. 16 schematically illustrates the configuration of the lignite-fired thermal power plant according to this embodiment.

A lignite-fired thermal power plant 201 according to this embodiment differs from that in the eleventh embodiment described above in that it includes a feed pipe (supply pipe) 140 that introduces (supplies) inert gas (e.g., N₂) into the second pipe 126b. Since other components are the same as those in the eleventh embodiment described above, descriptions of these components will be omitted here.

With the lignite-fired thermal power plant 201 according to this embodiment, since the feed pipes (supply pipes) 139 and 140 that supply exhaust gas from the boiler 5 and inert gas are connected to intermediate portions of the second pipe 126b, the oxygen concentration in the drying gas can be reduced to below 13%, or preferably, to below 10%, so that natural oxidation and spontaneous combustion of the lignite can be prevented, thereby allowing for increased safety and reliability.

The drying gas to be supplied to the drying device 122 is heated by the heater (second heater) 129, where the drying gas to be supplied to the drying device 122 is further heated, whereby the lignite can be dried more efficiently within a shorter period of time.

Because the cooler 128 and the heater 129 constitute the first compression heat pump (compression heat pump) 123, the heat captured in the cooler 128 is used for heating the drying gas in the heater 129, thereby increasing the thermal efficiency of the system.

Since other advantages are the same as those in the tenth embodiment described above, descriptions thereof will be omitted here.

A fourteenth embodiment of a lignite-fired thermal power plant according to the present invention will now be described with reference to FIG. 17.

FIG. 17 schematically illustrates the configuration of the lignite-fired thermal power plant according to this embodiment.

A lignite-fired thermal power plant 211 according to this embodiment differs from that in the thirteenth embodiment described above in that it includes the pulverized-coal collector 152 described above with reference to FIG. 12. Since other components are the same as those in the thirteenth embodiment described above, descriptions of these components will be omitted here.

The pulverized coal collected by the pulverized-coal collector 152 is delivered to the boiler 5 via the pulverized-coal hopper (bin) 212 for storing the pulverized coal, and dry exhaust separated from the pulverized coal is released to the atmosphere via the smokestack 9.

With the lignite-fired thermal power plant 211 according to this embodiment, the boiler 5 is supplied only with the pulverized coal serving as fuel, but is not supplied with gas containing moisture, so that heat loss caused by moisture (i.e., latent heat) in the boiler 5 can be further reduced, thereby further increasing the thermal efficiency of the entire plant.

Since other advantages are the same as those in the thirteenth embodiment described above, descriptions thereof will be omitted here.

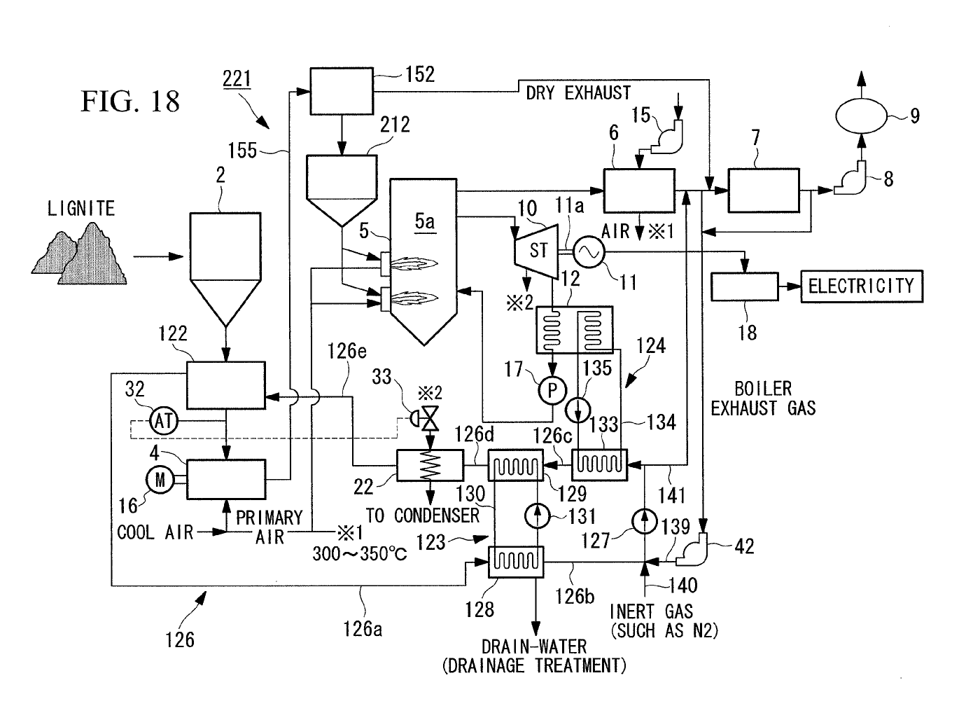

A fifteenth embodiment of a lignite-fired thermal power plant according to the present invention will now be described with reference to FIG. 18.

FIG. 18 schematically illustrates the configuration of the lignite-fired thermal power plant according to this embodiment.

A lignite-fired thermal power plant 221 according to this embodiment differs from that in the fourteenth embodiment described above in that the dry exhaust separated from the pulverized coal by the pulverized-coal collector 152 is guided to the electrostatic precipitator 7 so that dust and the like contained in small amounts in the dry exhaust are further removed by the electrostatic precipitator 7. Since other components are the same as those in the fourteenth embodiment described above, descriptions of these components will be omitted here.

With the lignite-fired thermal power plant 221 according to this embodiment, the electrostatic precipitator 7 further removes dust and the like from the dry exhaust gas separated from the pulverized coal by the pulverized-coal collector 152, and the dry exhaust gas is subsequently discharged (released) outside the system, thereby allowing for improved environmental performance.

Since other advantages are the same as those in the fourteenth embodiment described above, descriptions thereof will be omitted here.

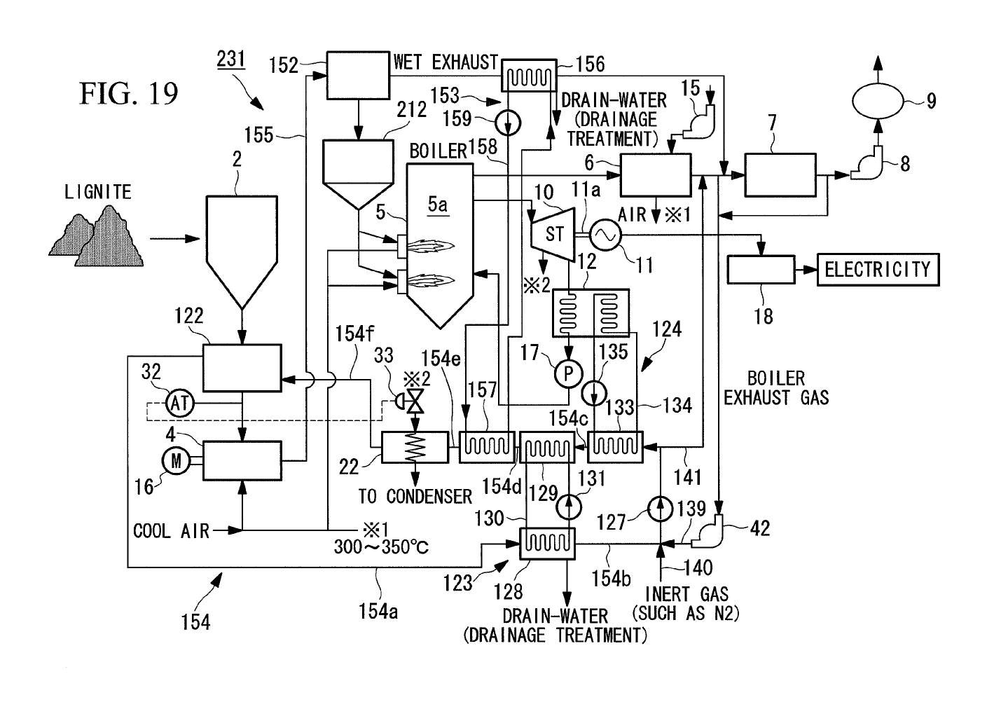

A sixteenth embodiment of a lignite-fired thermal power plant according to the present invention will now be described with reference to FIG. 19.

FIG. 19 schematically illustrates the configuration of the lignite-fired thermal power plant according to this embodiment.

A lignite-fired thermal power plant 231 according to this embodiment differs from that in the fifteenth embodiment described above in that it includes the third compression heat pump 153 described above with reference to FIG. 12 in place of the drying device 3 and the drying-gas heater 13, and also includes the pipework 154 (excluding the seventh pipe 154g) in place of the pipework 126. Since other components are the same as those in the fifteenth embodiment described above, descriptions of these components will be omitted here.

The dry exhaust traveling through the cooler 156 is guided to the electrostatic precipitator 7 so that dust and the like contained in small amounts in the dry exhaust are further removed by the electrostatic precipitator 7, and is subsequently released to the atmosphere via the smokestack 9.

With the lignite-fired thermal power plant 231 according to this embodiment, the drying gas to be supplied to the drying device 122 is heated by the heater (third heater) 157, where the drying gas to be supplied to the drying device 122 is further heated, whereby the lignite can be dried more efficiently within a shorter period of time.

Because the cooler (second cooler) 156 and the heater (third heater) 157 constitute the third compression heat pump (second compression heat pump) 153, the heat captured in the cooler 156 is used for heating the drying gas in the heater 157, thereby increasing the thermal efficiency of the system.

Since other advantages are the same as those in the fifteenth embodiment described above, descriptions thereof will be omitted here.

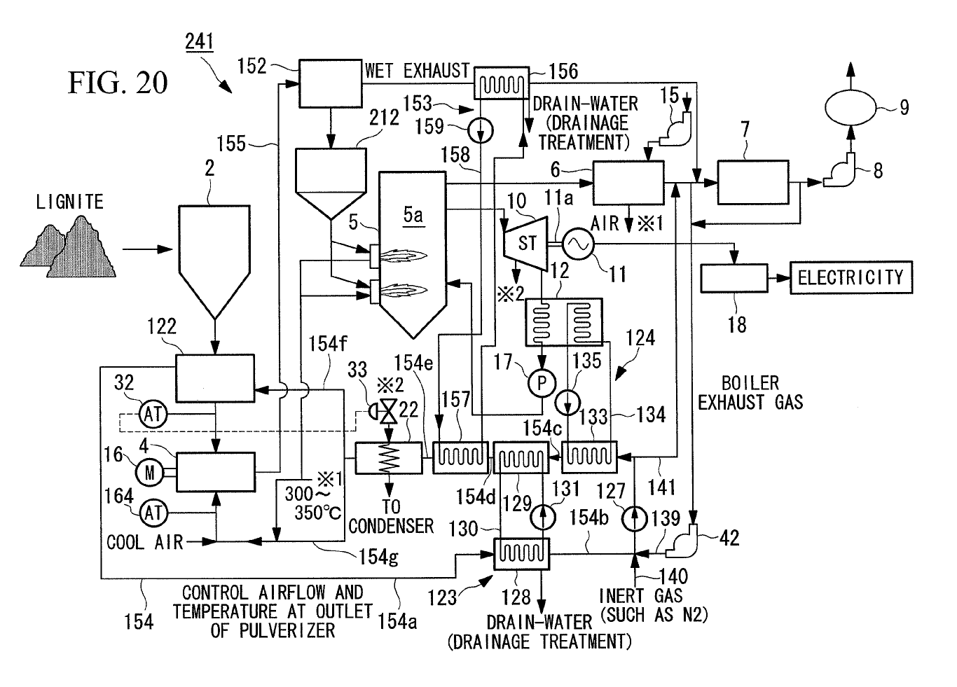

A seventeenth embodiment of a lignite-fired thermal power plant according to the present invention will now be described with reference to FIG. 20.

FIG. 20 schematically illustrates the configuration of the lignite-fired thermal power plant according to this embodiment.

A lignite-fired thermal power plant 241 according to this embodiment differs from that in the sixteenth embodiment described above in that it includes the seventh pipe 154g and the oxygen meter 164 described above with reference to FIG. 12. Since other components are the same as those in the sixteenth embodiment described above, descriptions of these components will be omitted here.

With the lignite-fired thermal power plant 241 according to this embodiment, the oxygen concentration in the drying gas to be supplied to the lignite mill 4 can be adjusted to below 13%, or preferably, to below 10%, so that natural oxidation and spontaneous combustion of the lignite can be prevented, thereby allowing for increased safety and reliability.

Since other advantages are the same as those in the sixteenth embodiment described above, descriptions thereof will be omitted here.

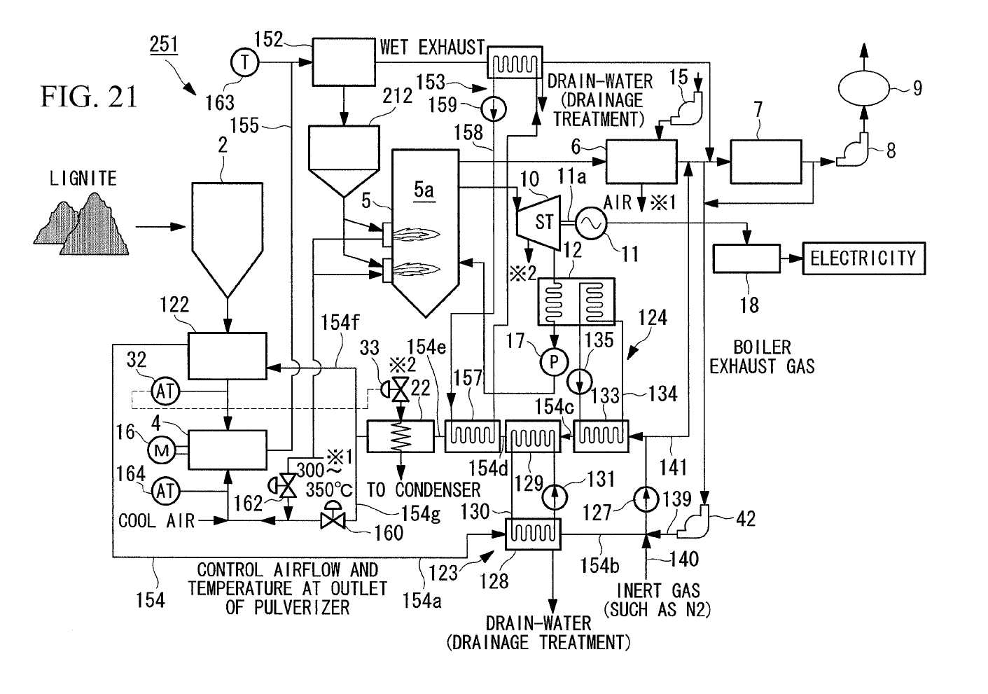

An eighteenth embodiment of a lignite-fired thermal power plant according to the present invention will now be described with reference to FIG. 21.

FIG. 21 schematically illustrates the configuration of the lignite-fired thermal power plant according to this embodiment.

A lignite-fired thermal power plant 251 according to this embodiment differs from that in the sixteenth embodiment described above in that it includes the flow control valves 160 and 162 and the thermometer 163 described above with reference to FIG. 12. Since other components are the same as those in the sixteenth embodiment described above, descriptions of these components will be omitted here.

With the lignite-fired thermal power plant 251 according to this embodiment, the temperature of the lignite supplied to the boiler 5 is properly controlled so that a good combustion state can be achieved within the boiler furnace 5a, thereby further increasing the thermal efficiency of the entire plant.

Since other advantages are the same as those in the sixteenth embodiment described above, descriptions thereof will be omitted here.

The present invention is not to be limited to the embodiments described above, and combinations, modifications, and alterations are permissible, where appropriate, so long as they do not depart from the spirit of the invention.

As an alternative to the collision-type drying and pulverizing device disclosed in FIG. 1 in Patent Literature 1 that is suitable for use as the drying device, a drying device of a gas-solid contact type may be used, such as a drying device of a parallel-flow box type, a vented box type, a rotatable type, a vented rotatable type, an airflow type, a fluidized bed type, a vented vertical type, a tunnel (parallel flow) type, a parallel-flow band type, a vented band type, an agitated trough type, or a rotatable type equipped with a heating tube.

In place of a lignite-fired thermal power plant, the lignite drying systems 101, 121, and 151 described above can also be applied to a thermal system plant (e.g., a boiler plant, a gasification furnace plant, or an integrated coal gasification combined cycle power plant).

### REFERENCE SIGNS LIST

1 lignite-fired thermal power plant
3 drying device
4 lignite mill (coal pulverizer)
5 boiler
7 electrostatic precipitator
9 smokestack
10 steam turbine
12 condenser
13 drying-gas heater
19 heat exchanger
21 thermal power plant
22 heater
31 thermal power plant
32 moisture meter
41 thermal power plant
51 thermal power plant
61 thermal power plant
71 thermal power plant
72 compression heat pump (heat pump)
81 thermal power plant
91 thermal power plant
101 drying system
102 drying device
103 wet gas condenser (condenser)
104 heater
105 pipework
121 drying system
122 drying device
123 first compression heat pump (compression heat pump)
126 pipework
128 cooler
129 heater (second heater)
130 pipe (second pipe)
131 compressor
133 heater
136 moisture meter
139 feed pipe (supply pipe)
140 feed pipe (supply pipe)
151 drying system
152 pulverized-coal collector
153 third compression heat pump (second compression heat pump)
154 pipework
156 cooler (second cooler)
157 heater (third heater)
158 pipe (third pipe)
159 compressor (second compressor)
171 thermal power plant
181 thermal power plant
191 thermal power plant
201 thermal power plant
211 thermal power plant
212 pulverized-coal hopper
221 thermal power plant
231 thermal power plant
241 thermal power plant
251 thermal power plant

1. A steam generating plant using low-grade coal as fuel, including a boiler that generates steam, a steam turbine that is driven by the steam, a condenser that captures the steam, after the steam has fulfilled its role in the steam turbine, and condenses the steam, and a coal pulverizer that pulverizes the low-grade coal to be supplied to the boiler into particles small enough that the low-grade coal can be used as fuel for the boiler, the steam generating plant comprising:
a drying device that dries the low-grade coal to be supplied to the coal pulverizer, and a drying-gas heater that heats air to be supplied to the drying device so as to be used for drying the low-grade coal,
wherein the condenser and the drying-gas heater are connected with each other via a heat exchanger, and exhaust heat from the condenser is used as a heat source for heating the air.

2. The steam generating plant using low-grade coal as fuel according to claim 1, wherein the air used for drying the low-grade coal within the drying device is forced into the boiler.

3. The steam generating plant using low-grade coal as fuel according to claim 1, wherein the air used for drying the low-grade coal within the drying device is directly released to the atmosphere via a smokestack located downstream of the boiler.

4. The steam generating plant using low-grade coal as fuel according to claim 1, wherein a heater that further heats the heated air to be supplied to the drying device from the drying-gas heater is provided between the drying device and the drying-gas heater.

5. A steam generating plant using low-grade coal as fuel, including a boiler that generates steam, a steam turbine that is driven by the steam, a condenser that captures the steam, after the steam has fulfilled its role in the steam turbine, and condenses the steam, and a coal pulverizer that pulverizes the low-grade coal to be supplied to the boiler into particles small enough that the low-grade coal can be used as fuel for the boiler, the steam generating plant comprising:
a drying device that dries the low-grade coal to be supplied to the coal pulverizer, and a drying-gas heater that heats boiler exhaust gas from the boiler, which is to be supplied to the drying device so as to be used for drying the low-grade coal,
wherein the condenser and the drying-gas heater are connected with each other via a heat exchanger, and exhaust heat from the condenser is used as a heat source for heating the boiler exhaust gas.

6. The steam generating plant using low-grade coal as fuel according to claim 5, wherein the boiler exhaust gas used for drying the low-grade coal within the drying device is forced into the boiler.

7. The steam generating plant using low-grade coal as fuel according to claim 5, wherein the boiler exhaust gas used for drying the low-grade coal within the drying device is directly released to the atmosphere via a smokestack located downstream of the boiler.

8. The steam generating plant using low-grade coal as fuel according to claim 5, wherein a heater that further heats the boiler exhaust gas to be supplied to the drying device from the drying-gas heater is provided between the drying device and the drying-gas heater.

9. The steam generating plant using low-grade coal as fuel according to claim 4, further comprising a moisture meter that detects moisture in the low-grade coal to be supplied to the coal pulverizer from the drying device, wherein a heat input level in the heater is set on the basis of a detection result obtained by the moisture meter.

10. The steam generating plant using low-grade coal as fuel according to claim 1, wherein a heat pump is provided in place of the heat exchanger.

11. A steam generating plant using low-grade coal as fuel, including a boiler that generates steam, a steam turbine that is driven by the steam, a condenser that captures the steam, after the steam has fulfilled its role in the steam turbine, and condenses the steam, and a coal pulverizer that pulverizes the low-grade coal to be supplied to the boiler into particles small enough that the low-grade coal can be used as fuel for the boiler, the steam generating plant comprising:
a drying device that dries the low-grade coal to be supplied to the coal pulverizer, and a drying-gas heater that heats air and boiler exhaust gas from the boiler, which are to be supplied to the drying device so as to be used for drying the low-grade coal,
wherein the condenser and the drying-gas heater are connected with each other via a heat exchanger, and exhaust heat from the condenser is used as a heat source for heating the air and the boiler exhaust gas.

12. The steam generating plant using low-grade coal as fuel according to claim 11, wherein the air and the boiler exhaust gas used for drying the low-grade coal within the drying device are forced into the boiler.

13. The steam generating plant using low-grade coal as fuel according to claim 11, wherein the air and the boiler exhaust gas used for drying the low-grade coal within the drying device are directly released to the atmosphere via a smokestack located downstream of the boiler.

14. The steam generating plant using low-grade coal as fuel according to claim 11, wherein a heater that further heats the air and the boiler exhaust gas to be supplied to the drying device from the drying-gas heater is provided between the drying device and the drying-gas heater.

15. The steam generating plant using low-grade coal as fuel according to claim 11, further comprising a moisture meter that detects moisture in the low-grade coal to be supplied to the coal pulverizer from the drying device, wherein a heat input level in the heater is set on the basis of a detection result obtained by the moisture meter.

16. The steam generating plant using low-grade coal as fuel according to claim 11, wherein a heat pump is provided in place of the heat exchanger.

17. The steam generating plant using low-grade coal as fuel according to claim 11, wherein a mixture ratio of the air and the boiler exhaust gas to be used for drying the low-grade coal within the drying device is measured and adjusted by an oxygen meter disposed at an inlet of the drying device.

18. The steam generating plant using low-grade coal as fuel according to claim 1, wherein the air is heated by boiler exhaust gas from the boiler so as to be used for drying the low-grade coal supplied to the coal pulverizer.

19. A drying system that dries low-grade coal within a drying device before the low-grade coal is supplied to a coal pulverizer,
wherein drying gas used for drying the low-grade coal circulates within a pipe connected to the drying device and forming a closed system.

20. The drying system according to claim 19, wherein a condenser or a cooler that condenses and captures moisture in the drying gas delivered from the drying device is provided at an intermediate portion of the pipe.

21. The drying system according to claim 20, wherein a heater that heats the drying gas is provided at an intermediate portion of the pipe, the intermediate portion being located between the condenser or the cooler and the drying device.

22. The drying system according to claim 21, wherein a second heater that heats the drying gas is provided at an intermediate portion of the pipe, the intermediate portion being located between the cooler and the drying device, and wherein the second heater and the cooler are connected with each other via a second pipe that forms a closed system independent of the closed system of the pipe and constitute a compression heat pump together with a compressor provided at an intermediate portion of the second pipe.

23. The drying system according to claim 20, wherein a third heater that heats the drying gas is provided at an intermediate portion of the pipe, the intermediate portion being located between the cooler and the drying device, and wherein the third heater and a second cooler that condenses and captures moisture in exhaust delivered from the coal pulverizer are connected with each other via a third pipe that forms a closed system independent of the closed systems of the pipe and the second pipe and constitute a second compression heat pump together with a second compressor provided at an intermediate portion of the third pipe.

24. A steam generating plant using low-grade coal as fuel, including the drying system according to claim 21, a boiler that generates steam, a steam turbine that is driven by the steam, a condenser that captures the steam, after the steam has fulfilled its role in the steam turbine, and condenses the steam, and a coal pulverizer that pulverizes the low-grade coal to be supplied to the boiler into particles small enough that the low-grade coal can be used as fuel for the boiler,
wherein exhaust heat from the condenser is supplied to the heater so as to be used as a heat source for heating the drying gas.

25. The steam generating plant using low-grade coal as fuel according to claim 24, wherein a supply pipe that supplies inert gas and/or exhaust gas from the boiler is connected to an intermediate portion of the pipe.

26. The steam generating plant using low-grade coal as fuel according to claim 24, wherein a pulverized-coal collector that collects dust from the pulverized coal is provided between the coal pulverizer and a pulverized-coal hopper to which the pulverized coal serving as fuel for the boiler is supplied.

27. The steam generating plant using low-grade coal as fuel according to claim 26, wherein exhaust delivered from the pulverized-coal collector is delivered to an electrostatic precipitator that collects dust in exhaust gas coming from the boiler, and is processed in the electrostatic precipitator.

28. The steam generating plant using low-grade coal as fuel according to claim 21, further comprising a moisture meter that detects moisture in the low-grade coal to be supplied to the coal pulverizer from the drying device, wherein a heat input level in the heater and/or the second heater and/or the third heater is set on the basis of a detection result obtained by the moisture meter.

29. A thermal power plant using low-grade coal as fuel, comprising the steam generating plant according to claim 1.

30. A thermal system plant comprising the drying system according to claim 19.

31. The steam generating plant using low-grade coal as fuel according to claim 8, further comprising a moisture meter that detects moisture in the low-grade coal to be supplied to the coal pulverizer from the drying device, wherein a heat input level in the heater is set on the basis of a detection result obtained by the moisture meter.

32. The steam generating plant using low-grade coal as fuel according to claim 5, wherein a heat pump is provided in place of the heat exchanger.

33. The steam generating plant using low-grade coal as fuel according to claim 5, wherein the air is heated by boiler exhaust gas from the boiler so as to be used for drying the low-grade coal supplied to the coal pulverizer.

34. The steam generating plant using low-grade coal as fuel according to claim 11, wherein the air is heated by boiler exhaust gas from the boiler so as to be used for drying the low-grade coal supplied to the coal pulverizer.

35. A thermal power plant using low-grade coal as fuel, comprising the steam generating plant according to claim 5.

36. A thermal power plant using low-grade coal as fuel, comprising the steam generating plant according to claim 11.
